(19) United States
(12) Patent Application Publication
(10) Pub. No.: US 2024/0159855 A1
(43) Pub. Date: May 16, 2024

(54) METHODS AND SIGNALING FOR ENABLING CARRIER PHASE-BASED POSITIONING IN A WIRELESS COMMUNICATION SYSTEM

(71) Applicants: Indian Institute of Technology Kanpur, Kanpur (IN); Centre of Excellence in Wireless Technology, Chennai (IN)

(72) Inventors: Jyotirmay Saini, Kanpur (IN); Abhijeet Abhimanyu Masal, Chennai (IN); Shyam Vijay Gadhai, Kanpur (IN); Shiv Shankar, Chennai (IN); Jeniston Deviraj Klutto Milleth, Chennai (IN); Rohit Budhiraja, Kanpur (IN)

(21) Appl. No.: 18/508,812

(22) Filed: Nov. 14, 2023

(30) Foreign Application Priority Data
Nov. 15, 2022 (IN) 202241065411

(51) Int. Cl. G01S 5/02; G01S 5/00; H04W 64/00

(52) U.S. Cl. CPC G01S 5/0244; G01S 5/0081; G01S 5/0218; G01S 5/0236; H04W 64/003; G01S 2205/008

(57) ABSTRACT

A method for positioning in a wireless communication system is described. The method comprises receiving, by a second node (102), a capability-request signal from a first node (106). The second node (102) transmits a capability-response signal to the first node (106). The second node (102) transmits an assistance information to the first node (106). The second node (102) transmits the configuration of the at least one reference signal to a third node (104). The second node (102) receives a reference signal from the third node (104). The second node (102) performs measurement on the reference signal and transmits report comprising the measurement to the first node (106), where the first node (106) estimates a position of the third node (104) based on the report received from the second node (102).

### CROSS-REFERENCE TO RELATED APPLICATIONS

This application claims priority pursuant to India Patent Application No. 202241065411, filed Nov. 15, 2022, which application is incorporated herein by reference in its entirety.

### FIELD OF THE INVENTION

The present invention relates to a wireless communication system, and more particularly to method for performing carrier phase-based positioning in the wireless communication system and signalling methods to enable carrier phase-based positioning in the wireless communication system.

### BACKGROUND OF THE INVENTION

5G New Radio (NR) is designed to enable services like enhanced mobile broadband, ultra-reliable low latency, and massive machine-type communication. The radio access network of 5G offers value-added services like positioning by helping the user to find its location (geo location coordinates). Positioning and localization is one of the most vital features of the 5G NR which evolves through the evolution of mobile communication. In the early stages of cellular evolution, positioning emerged as an essential use case due to regulatory requirements from the Federal Communications Commission (FCC) for emergency calls. In the later stages, many other critical services that rely on positioning has emerged with requirements on accuracy, Time To First Fix (TTFF), and latency.

Third-generation partnership project (3GPP), IEEE, and other standard-bearing organizations focuses on providing an accurate positioning measurement of User Equipment (UE) of different types. 3GPP technologies such as Long-Term Evolution (LTE), LTE-Advanced, and 5G New Radio (NR) are currently working on the sub-meter positioning accuracy of the UE. Improving the positioning accuracy of the UE may help to protect Vulnerable Road Users (VRUs) such as pedestrians, wheelchairs, and cyclists from vehicles, especially autonomously driving vehicles. In industrial applications and Internet of Things (IoT) use cases, positioning and localization are critical for their operation, which is further constrained by low latency, low TTFF along with sub-meter level accuracy.

In 5G NR, different positioning methods are standardized. The positioning methods are Downlink-Time Difference of Arrival (DL-TDoA), Enhanced Cell-ID (E-CID), Observed Time Difference of Arrival (OTDoA), Uplink Angle of Arrival (UL-AoA), Uplink Relative Time of Arrival (UL-RToA), Uplink Time Difference of Arrival (UL-TDoA), Multi-Round Trip Time (M-RTT), etc. 3GPP TS 23.273 document provides support for enhancement in architecture for positioning and unique positioning-related protocols like the LTE Positioning Protocol (LPP), NR Positioning Protocol annex (NRPPa), and LTE Positioning Protocol annex (LPPa).

FIG. 1 illustrates an architecture and interface for positioning in a wireless communication network 100, in accordance with prior art. In 5G/LTE, the positioning of a target UE 104 is triggered based on the request made to a Location Management Server (LMF) 106-b, which is a network entity of the 5G Core Network (CN) and interfaces with the Next Generation (NG) Radio Access Network (NG-RAN) via Access and Mobility Management Function (AMF) 106-a. This request is generated by one of the networks nodes like the AMF 106-a, the LMF 106-b, the target UE 104, or any external agent 108. The LMF 106-b interacts with the AMF 106-a and NG-RAN via standard interface Network Links (NLs) and NRPPa (NLs-NG-C-), respectively. The server terminates at the UE 104 through the LPP protocol, which is transparent to NG-RAN.

The NRPPa and LPP may enable exchange of necessary information elements between NG-RAN and server (includes the AMF 106-a, the LMF 106-b), and the target UE 104 and server, respectively. The 5G positioning architecture also allows positioning the target UE 104 based on NG-eNB via LPP (RRC) protocol for non-standalone (NSA) mode. The target UE 104 and NG-RAN perform measurements with respect to each other over NR-Uu and LTE-Uu for NB-Transmission Reception Points (TRPs) and NG-eNB-TRPs in NSA and SA modes, respectively. For Downlink (DL)-based positioning, the AMF 106-a/LMF 106-b may provide configurations to the NG-RAN for transmitting (or broadcasting) Reference Signals (RSs) to the target UE 104 for performing measurements.

For Uplink (UL)-based positioning, the AMF 106-a/LMF 106-b may provide resource configurations to the target UE 104 for transmitting (or broadcasting) RSs and to NG-RAN for performing measurements using the RSs. The resource configurations provided to the transmitter indicates the parameters for generation and transmission of RSs, repetition/periodicity of RS resource(set)s, transmission filters, transmission frequency bands, etc. The resource configurations for the receiver contain RS-IDs, measurement windows, measurement gaps, frequency bands, receive filters, etc.

In 5G, new positioning methods are standardized to improve the accuracy of the existing methods and to achieve substantial improvement in the accuracy of new methods compared to the existing methods. One of the method for positioning is based on the measurement of Carrier Phase (CP) of the received signal at the receiver from the transmitter. The received carrier phase is a function of the distance traveled in terms of the multiple of wavelength of the carrier. In the OFDM system, the carrier phase over multiple sub-carriers may be exploited to get robust phase measurement which in turn is used for distance measurement between transmitter and receiver. The present invention provides various methods for carrier phase measurement in OFDM system and signaling methods between the AMF 106-a/LMF 106-b, the target UE 104, and gNBs to enable each one of the methods.

The CP-based positioning is a promising candidate technique to meet the service requirements for various applications. CP-based positioning is already used in the Global Navigation Satellite System (GNSS) and the Navigation with the Indian Constellation (NavIC). The present invention provides various methods to enable the carrier phase-based positioning in the existing 5G positioning framework to improve accuracy. Also, the signaling required to enable the CP-based positioning methods and the techniques to mitigate the error in these measurements is also described.

The carrier phase-based positioning is a well-known measurement technique in the GNSS system. The carrier phase measurement is defined as the phase measured at the receiver over predefined signal transmitted from the transmitter with known locations. The measurement of the carrier phase is performed between the Transmitter (Tx) Antenna Reference Point (ARP) and the Receiver (Rx) ARP. There are various challenges in carrier phase measurements. In carrier phase-based positioning, the range is expressed in wave cycles between the transmitter and receiver. If the distance between the transmitter and receiver is multiple of the wave cycle, the fractional difference phase between the received signal and the reference signal can be calculated, but the integer number of cycles waves between the transmitter and receiver is not measurable. This is referred as Integer Ambiguity (IA). The prominent challenge in the carrier phase-based positioning is to provide techniques for the resolution of IA to get robust carrier phase measurement. Further, the transmitter and receiver may have various error sources which introduce a constant or variable phase into the received signal, which is also independent of the distance between the Tx and Rx. Such sources are Carrier Frequency Offset (CFO), Doppler shift between Tx and Rx, oscillator drift, Tx/Rx ARP location errors, phase center offset and initial phase offset at Tx/Rx. Further, in the wireless channel in terrestrial networks, the multi-path between Tx and Rx and the absence of a line of sight (LoS) path may further deteriorate the accuracy of phase measurement. Apart from this, the carrier phase measurement inherently provides the resolution of 1%-5% of the wavelength of the carrier. Therefore, to achieve centimeter-level accuracy with the carrier phase measurement, it is necessary to mitigate these error sources.

The base idea of carrier phase-based positioning is to measure the phase of the carrier, which is the function of the distance. The carrier phase-based positioning aims to provide fairly accurate measurement of phase over predefined signal transmitted from one or more than one transmitting node. In terrestrial network, especially in 3GPP technologies, RS with known sequence at the transmitter and receiver is transmitted from the transmitting nodes to the receiving node for positioning purpose. The receiver receives at least one RS and performs the carrier phase-based measurement using either configured carrier phase measurement method or chooses by its own one of the possible methods to measure the carrier phase. If a Rx node assisted method is configured by positioning server or measuring entity other than receiving node, then receiving node will report back the measurement in configured way along with method used and related parameters if not configured explicitly. If the measuring entity is Rx node itself, then Rx node will use these measurements and estimate the final location and report back to other entity of application etc. These RSs may be known as Positioning Reference Signal (PRS). In NR, a dedicated PRS is designed for downlink (DL) transmission where PRS is transmitted from transmission-reception points (TRPs)/gNBs to UE. Whereas for uplink, sounding reference signal (SRS) is reused for positioning purpose with some modification. For carrier phase-based positioning same RS can be reused or other available RS in DL and/UL can be used for this purpose e.g., PRACH preamble, Channel State Information RS (CSI RS), Synchronization Block (SSB) or Demodulation RS (DMRS) etc. In the present invention, DL-PRS, UL-SRS or any other available RS for positioning purpose may be referred as PRS in general unless otherwise mentioned explicitly. In general, based on the direction of transmission of the PRS, carrier phase-based positioning can be categorized as DL carrier phase-based positioning and UL carrier phase-based positioning.

The present invention provides various methods for carrier phase-based positioning, signaling methods to enable carrier phase-based positioning, and ways to mitigate error sources in carrier phase-based positioning.

### OBJECTS OF THE INVENTION

A general objective of the present invention is to provide a method for carrier phase-based positioning in a wireless communication system.

Another objective of the invention is to provide signalling methods to enable carrier phase-based positioning in the wireless communication system.

Still another objective of the present invention is to improve accuracy of measurement and mitigate error sources in carrier phase-based positioning.

### SUMMARY OF THE INVENTION

The summary is provided to introduce aspects related to channel bandwidth adaptation in a cellular network, and the aspects are further described below in the detailed description. This summary is not intended to identify essential features of the claimed subject matter nor is it intended for use in determining or limiting the scope of the claimed subject matter.

In one embodiment, a method for positioning a third node in a wireless communication system is described. The method comprises receiving, by at least one second node, a capability-request signal from at least one first node. The method further comprises transmitting, by the at least one second node, a capability-response signal to the at least one first node, where the capability-response signal comprises at least one of at least one frequency resource supported, at least one supported positioning method, support for carrier phase positioning, at least one measurement supported, at least one granularity of performing the at least one measurement supported and at least one technique supported to resolve integer ambiguity. The method further comprises transmitting, by the at least one second node, an assistance information to the at least one first node, where the assistance information comprises at least one of the at least one frequency resource to be used for the measurement, the at least one measurement to be used, the at least one granularity of performing the at least one measurement, the at least one technique supported to resolve integer ambiguity, at least one reference signal configuration information and at least one scheduling information of at least one reference signal to be used for the measurement. Further, the method comprises transmitting, by the at least one second node, the configuration information of the at least one reference signal to the at least one third node. Also, the method comprises receiving, by the at least one second node, the at least one reference signal from the at least one third node. The method further comprises performing, by the at least one second node, at least one measurement on the at least one reference signal, where the at least one measurement is with respect to Antenna Reference Point. The method further comprises transmitting, by the at least one second node, at least one report comprising the at least one measurement to the at least one first node, where the at least one first node estimates a position of the at least one third node based on the at least one report received from the at least one second node.

In one aspect, the at least one measurement comprises at least one of at least one carrier phase measurement and at least one timing-based measurement, of the at least one reference signal received from the at least one third node and the at least one carrier phase measurement comprises of at least one carrier phase of at least one the received reference signal and at least one timestamp of the measurement.

In one aspect, the at least one first node is one of a positioning server, a location management function (LMF) server, an Access and Mobility Management Function (AMF) server, and sidelink positioning/ranging server. The least one second node is one of a base station, a gNB, an eNB, a relay node, an integrated access and backhaul (IAB) node, a Vehicle-to-Everything (V2X) node, a Transmission Reception Point (TRP), anchor user equipment (UE) and a repeater in a cellular network. The at least one-third node is one of the target UE and Positioning reference unit (PRU), where the target UE is the node whose location is to be determined.

In one aspect, the method further comprises receiving, by the at least one second node, a positioning-request signal from at least one of the at least one first node and the at least one third node, to assist at least one of the at least one first node and the at least one third node in estimating the position of the at least one third node.

In one aspect, the assistance information is transmitted by the at least one second node to the at least one first node upon receiving the assistance information-request from the at least one first node.

In one aspect, the Antenna Reference Point comprises at least one of an antenna connector, transceiver array boundary connector, physical antenna, and central radiating region of antenna.

In one aspect, the timing-based measurements comprises at least one of second node Rx-Tx time difference is the difference between the time at which the at least one reference signal is received by the at least one of second node and the time at which a reference signal is transmitted by the same second node. The at least one third node Rx-Tx time difference is the difference between the time at which the at least one reference signal is received by the at least one of third node and the time at which a reference signal is transmitted by the same third node. The relative time of arrival (RTOA) where the RTOA is the relative time taken by reference signal with respect to a reference time, to reach from the at least one third node to the at least one second node. The reference signal time difference (RSTD) is the difference between the relative time taken by reference signal to reach from the at least one second node to the at least one third node and the relative time taken by reference signal to reach from one of an another second node to of the same third node.

In one aspect, when at least the at least one carrier phase measurement and timing-based measurements are supported, the capability information comprises at least one indication that the at least one second node is capable of measuring and reporting the at least one carrier phase on the same reference signal resources as configured for timing-based measurements.

In one aspect, when at least the at least one carrier phase measurement and timing-based measurements are supported, the configuration signal comprises at least one indication for the at least one second node to report the at least one carrier phase on the same reference signal resources as configured for timing-based measurements.

In one aspect, where when at least the at least one carrier phase measurement is supported, the capability information comprises at least one indication that the at least one carrier phase measurement is supported for at least one of first path and multiple paths.

In one aspect, when the at least one carrier phase measurement is supported, the configuration signal comprises at least one indication that whether the at least one carrier phase measurement is to be reported for multiple paths or not.

In one aspect, the at least one carrier phase measurement for the first path is reported, and additionally the at least one carrier phase measurement for other multiple paths is reported if configured, where the first path is a line of sight (LoS) path.

In one aspect, the at least one reference signal is a sounding reference signal (SRS) and the configuration of the at least one reference signal comprises of at least one of the at least one reference signal resource and at least one resource set.

In one aspect, receiving the at least one reference signal is a sounding reference signal (SRS), the SRS is received in a full stagger pattern, the plurality of SRS signals is concatenated over a full frequency band of transmission and the at least one second node measures the at least one carrier phase over the concatenated resource signals.

In one aspect, the position of the at least one third node is one of an absolute position with respect to global coordinates and a relative position with respect to the at least one first node or the at least one second node, and distance between the at least one second node, and the at least one third node.

In one aspect, the at least one carrier phase is difference between the phase of the received reference signal and the transmitted reference signal.

In one aspect, performing the at least one carrier phase measurement on a plurality of received reference signals from a plurality of nodes is used to estimate the at least one carrier phase difference and report the at least one carrier phase difference to the at least one first node.

In one aspect, where the carrier phase difference is the difference between the at least one carrier phase of the received reference signal form one of the at least one third node and the at least one carrier phase of the received reference signal from one of an another at least one third node.

In one aspect, the at least one second node calibrates and reports the errors occurring at the at least one second node during the at least one carrier phase measurement, and where the errors include Transmission-Reception Points (TRP) synchronization error, Carrier Frequency Offset (CFO) error, antenna phase center offset, and oscillator drift.

In one aspect, the at least one second node estimates the quality of the at least one carrier phase measurement and reports it to the at least one first node, where the quality of the at least one carrier phase measurement is based on a residual error in the phase based on the at least one carrier phase measured and reported.

In one aspect, the capability information further comprises at least one of frequency ranges supported, Positioning Frequency Layer (PFL), granularity of performing the at least one measurement at carrier level, subcarrier level, and both, or able to report the phase measurement of a virtual carrier, positioning methods supported comprising of at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method, capability of identifying and reporting the measurement for Line of Sight (LoS) and Non Line of Sight (NLoS) signals, and at least one technique supported to resolve integer ambiguity.

In one aspect, the capability information further comprises at least one of a method to measure the at least one carrier phase and a Boolean indicator to indicate possibility of integer ambiguity resolution.

In one aspect, the assistance information further comprises at least one of a Physical Cell Identity (PCI), Global Cell Identity (GCI), Absolute Radio Frequency Channel Number (ARFCN), an ID of the at least one second node serving the at least one third node, timing information of the at least one second node serving the at least one third node, SRS configuration of the at least one third node served by the at least one second node, SSB information of the at least one third node, Spatial direction information of the SRS resources of the at least one third node served by the at least one second node, Geographical coordinates information of the at least one second node serving the at least one third node, node type, On-demand SRS information, timing advance, at least one technique supported to resolve integer ambiguity, and integer ambiguity value.

In one aspect, the at least one carrier phase measurements are performed over a plurality of frequency resources, the measurements reported further comprises at least one of the frequency resource values per carrier phase measurement, and the difference between the frequency resource values per carrier phase measurement, and the frequency resource values comprise of at least one of a frequency carrier, a frequency subcarrier, a frequency band, and a frequency range.

In one aspect, the at least one report further comprises at least one of channel response in time and frequency, difference between two measurements in frequency domain for multiple frequency resources, frequency spacing between the at least one pair of frequency resources, distance between the at least one second node and the at least one third node, slope of the phase measurement when the at least one measurement is performed over plurality of frequency resources.

In one aspect, the at least one carrier phase measurement corresponding to at least one of the first path and the additional paths, comprises of at least one likelihood value, where the likelihood value is at least one of a soft value ranging between 0 and 1, and a hard value comprising of one of 0 and 1, where the likelihood values corresponds to likelihood whether the at least one carrier phase measurement is for one of LoS path, and NLoS path.

In one aspect, the at least one report further comprises signal strength corresponding to the measurement, errors in measurement, where the errors include clock error, Timing Error Group (TEG), and initial clock error, a New Radio Cell Global Identity (NCGI) and TRP ID of the measurement, the relative time of arrival (RToA), UL SRS-RSRP, UL SRS-RSRPP, multiple UL Angle of Arrival (AoA), SRS resource type, time stamp of the measurement, quality for each measurement, beam information for each measurement, Antenna Reference Point (ARP) ID of the measurement, the carrier phase over the at least one SRS, integer ambiguity value, carrier phases per antenna port, carrier phases per antenna panel, carrier phases per antenna element, and Phase Correction Offsets.

In one aspect, the integer ambiguity value denotes an integer number of wave cycles between the at least one second node and the at least one third node. The method further comprises at least one of determining, by the at least one second node, the integer ambiguity value, transmitting, by the at least one second node, the integer ambiguity value to the at least one first node one of implicitly and explicitly and determining, by the at least one first node, the integer ambiguity value based on the at least one report.

In one aspect, the method further comprises configuring, by the at least one second node, at least one third node to transmit the at least one reference signal in a carrier frequency having wavelength greater than the actual distance between the at least one second node and the at least one third node. The method further comprises measuring, by the at least one second node, the at least one carrier phase of the at least one reference signal in the single carrier frequency using a carrier of wavelength greater than the actual distance between the at least one second node and the at least one third node and transmitting, by the at least one second node, the at least one report comprising of the measurements to the at least one first node to resolve the ambiguity.

In one aspect, the method further comprises receiving, by the at least one second node, at least one of at least one reference signal and at least one pseudo-random code sequence on the at least one frequency resource from the at least one third node. The method further comprises measuring, by the at least one second node, at least one of the at least one carrier phase of the at least one reference signal and the at least one carrier phase of the at least one pseudo-random code sequence on the at least one frequency resource, where the integer ambiguity is resolved using at least one of the at least one carrier phase of the at least one reference signal and the at least one carrier phase of the at least one pseudo-random code sequence and transmitting, by the at least one second node, the at least one report comprising of the measurements to the at least one first node. The at least one pseudo-random code sequence is at least a physical random access channel (PRACH) preamble signal to resolve the ambiguity.

In one aspect, when the at least one measurements comprise of the at least one carrier phase measurement over a plurality of frequency resources, the at least one report comprises of the at least one carrier phase difference between at least one pair of frequency resources, which is used to resolve the integer ambiguity.

In one embodiment, a method for positioning a third node in a wireless communication system is described. The method comprises receiving, by at least one third node, a capability request signal from at least one of at least one first node and at least one second node. The method further comprises transmitting, by the at least one third node, a capability response signal to at least one of the at least one first node and the at least one second node, where the capability response signal comprises at least one of at least one frequency resource supported, at least one supported positioning method, support for carrier phase positioning, at least one measurement supported, at least one granularity of performing the at least one measurement supported, at least one technique supported to resolve integer ambiguity. The method further comprises receiving, by the at least one third node, a configuration signal from at least one of the at least one first node and the at least one second node, where the configuration signal comprises at least one of the at least one frequency resource to be used for the measurement, at least one measurement to be used, at least one granularity of performing the at least one measurement, at least one method supported to resolve integer-ambiguity, and at least one scheduling information and configuration information of the at least one reference signal to be used for the measurement. The method further comprises receiving, by the at least one third node, at least one reference signal from the at least one second node. The method further comprises performing, by the at least one third node, at least one of at least one measurement on the at least one reference signal and estimating a position of the at least one third node, where the at least one measurement is with respect to Antenna Reference Point. Further, the method comprises transmitting, by the at least one third node, at least one report comprising at least one of at least one measurement and the position of the at least one third node to at least one of the at least one first node and the at least one second node.

In one aspect, the at least one measurement comprises at least one of at least one carrier phase measurement and at least one timing-based measurement, of the at least one reference signal received from the at least one second node and the at least one carrier phase measurement comprises of at least one carrier phase of at least one the received reference signal and at least one timestamp of the measurement.

In one aspect, the at least one first node is one of a positioning server, a location management function (LMF) server, an Access and Mobility Management Function (AMF) server, and sidelink positioning/ranging server. The at least one second node is one of a base station, a gNB, an eNB, a relay node, an integrated access and backhaul (IAB) node, a Vehicle-to-Everything (V2X) node, a Transmission Reception Point (TRP), anchor user equipment (UE) and a repeater in a cellular network and the at least one-third node is one of the target UE and Positioning reference unit (PRU), where the target UE is the node whose location is to be determined.

In one aspect, the method further comprises transmitting, by the at least one third node, a positioning-request signal to at least one of the at least one first node and the at least one second node, to assist the at least one third node in estimating the position of the at least one third node.

In one aspect, the method further comprises receiving, by the at least one third node, the positioning-request signal from at least one of the at least one first node and the at least one second node, to assist the at least one first node in estimating the position of the at least one third node.

In one aspect, the Antenna Reference Point comprises at least one of an antenna connector, transceiver array boundary connector, physical antenna, and central radiating region of antenna.

In one aspect, the timing-based measurements comprises at least one of second node Rx-Tx time difference where Rx-Tx time difference is the difference between the time at which at least one reference signal is received by the at least one of second node and the time at which a reference signal is transmitted by the same second node. The at least one third node Rx-Tx time difference is the difference between the time at which at least one reference signal is received by the at least one of third node and the time at which a reference signal is transmitted by the same third node. The relative time of arrival (RTOA) is the relative time taken by reference signal with respect to a reference time, to reach from the at least one third node to the at least one second node. The reference signal time difference (RSTD) is the difference between the relative time taken by reference signal to reach from the at least one second node to the at least one third node and the relative time taken by reference signal to reach from one of an another second node to of the same third node.

In one aspect, when the at least one carrier phase measurement and timing-based measurements are supported, the capability information comprises at least one indication that the at least one third node is capable of measuring and reporting the at least one carrier phase on the same reference signal resources as configured for timing-based measurements.

In one aspect, when at least the at least one carrier phase measurement and timing-based measurements are supported, the configuration signal comprises at least one indication for the at least one third node to report the at least one carrier phase on the same reference signal resources as configured for timing-based measurements.

In one aspect, when at least the at least one carrier phase measurement is supported, the capability information comprises at least one indication that the at least one carrier phase measurement is supported for at least one of first path and multiple paths.

In one aspect, when at least the at least one carrier phase measurement is supported, the configuration signal comprises at least one indication that whether the at least one carrier phase measurement is to be reported for multiple paths or not.

In one aspect, the at least one carrier phase measurement for the first path is reported, and additionally the at least one carrier phase measurement for other multiple paths is reported if configured, where the first path is a line of sight (LoS) path.

In one aspect, when the at least one report comprises of only measurements, the at least one first node estimates the position of at least one third node based on the at least one report received form at least one third node.

In one aspect, the at least one reference signal is a positioning reference signal (PRS) and the configuration of the at least one reference signal comprises of at least one of the at least one reference signal resource and resource set.

In one aspect, receiving the at least one reference signal is a positioning reference signal (PRS), and the PRS in a full stagger pattern, the plurality of PRS signals is concatenated over a full frequency band of transmission and the at least one third node measures the at least one carrier phase over the concatenated resource signals.

In one aspect, the position of the at least one third node is one of an absolute position with respect to global coordinates and a relative position with respect to the at least one first node or the at least one second node, and distance between the at least one third node, and the at least one second node.

In one aspect, the at least one carrier phase is difference between the phase of the received reference signal and the transmitted reference signal.

In one aspect, performing the at least one carrier phase measurement on a plurality of received reference signals from a plurality of nodes is used to estimate the at least one carrier phase difference and report the at least one carrier phase difference to at least one of the at least one first node and the at least one second node.

In one aspect, the at least one carrier phase difference is the difference between the at least one carrier phase of the received reference signal form one of the at least one second node and the at least one carrier phase of the received reference signal from one of an another at least one second node.

In one aspect, the at least one third node calibrates and reports the errors occurring at the at least one third node during the at least one carrier phase measurement, and where the errors include Transmission-Reception Points (TRP) synchronization error, Carrier Frequency Offset (CFO) error, antenna phase center offset, and oscillator drift.

In one aspect, the at least one third node estimates the quality of the at least one carrier phase measurement and reports it to the at least one of the at least one first node and the at least one second node, where the quality of the at least one carrier phase measurement is based on a residual error in the phase based on the at least one carrier phase measured and reported.

In one aspect, the capability information further comprises at least one of frequency ranges supported, Positioning Frequency Layer (PFL), granularity of performing the at least one measurement at carrier level, subcarrier level, and both, or able to report the phase measurement of a virtual carrier, positioning methods supported comprising of at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method, capability of identifying and reporting the measurement for Line of Sight (LoS) and Non Line of Sight (NLoS) signals, and at least one technique supported to resolve integer ambiguity.

In one aspect, when the capability information comprises carrier phase positioning supported, the capability information further comprises a method to measure the at least one carrier phase and a Boolean indicator to indicate possibility of integer ambiguity resolution.

In one aspect, method further comprises receiving, by the at least one third node, assistance information from the at least one of the at least one first node and the at least one second node, where the assistance information comprises at least one of Physical Cell Identity (PCI), Global Cell Identity (GCI), Absolute Radio Frequency Channel Number (ARFCN), and ID of the at least one second node serving the at least one third node, Timing information of the at least one second node serving the at least one third node, PRS configuration of the at least one second node serving by the at least one third node, SSB information of the at least one second node, Spatial direction information of the PRS resources of the at least one second node serving the at least one third node, Geographical coordinates information of the at least one second node serving the at least one third node, node type, On-demand PRS information, timing advance, at least one technique supported to resolve integer ambiguity, and integer ambiguity value.

In one aspect, the at least one carrier phase measurements are performed over a plurality of frequency resources, the measurements reported further comprises at least one of the frequency resource values per carrier phase measurement, and the difference between the frequency resource values per carrier phase measurement and the frequency resource values comprise of at least one of a frequency carrier, a frequency subcarrier, a frequency band, and a frequency range.

In one aspect, the at least one report further comprises at least one of channel response in time and frequency, difference between two measurements in frequency domain for multiple frequency resources, frequency spacing between the at least one pair of frequency resources, distance between the at least one second node and the at least one third node, slope of the phase measurement when the at least one measurement is performed over plurality of frequency resources.

In one aspect, the at least one carrier phase measurement corresponding to at least one of the first path and the additional paths comprises of at least one likelihood value, where the likelihood value is at least one of a soft value ranging between 0 and 1, and a hard value comprising of one of 0 and 1, where the likelihood values corresponds to likelihood whether the at least one carrier phase measurement is for one of LoS path and NLoS path.

In one aspect, the at least one report further comprises signal strength corresponding to the measurement, errors in measurement, where the errors include clock error, Timing Error Group (TEG), and initial clock error, a New Radio Cell Global Identity (NCGI) and TRP ID of the measurement, the reference signal time difference (RSTD), DL PRS-RSRP, DL PRS-RSRPP, multiple DL Angle of Departure (AoD), PRS resource type, time stamp of the measurement, quality for each measurement, beam information for each measurement, Antenna Reference Point (ARP) ID of the measurement, the carrier phase over the at least one PRS, integer ambiguity value, carrier phases per antenna port, carrier phases per antenna panel, carrier phases per antenna element, and Phase Correction Offsets.

In one aspect, the integer ambiguity value denotes an integer number of wave cycles between the at least one second node and the at least one third node. The method further comprises at least one of determining, by the at least one third node, the integer ambiguity value, transmitting, by the at least one third node, the integer ambiguity value to the at least one of the at least one first node and the at least one second node one of implicitly and explicitly and determining, by the at least one first node, the integer ambiguity value based on the at least one report.

In one aspect, the method further comprises receiving, by the at least one third node, the configuration from the at least one second node to receive the at least one reference signal in a carrier frequency having wavelength greater than the actual distance between the at least one second node and the at least one third node. The method further comprises measuring, by the at least one third node, the at least one carrier phase of the at least one reference signal in the single carrier frequency using a carrier of wavelength greater than the actual distance between the at least one second node and the at least one third node and transmitting, by the at least one third node, the at least one report comprising of the measurements to at least one of the at least one first node and the at least one second node to resolve the ambiguity.

In one aspect, the method further comprises receiving, by the at least one third node, at least one of at least one reference signal and at least one pseudo-random code sequence on the at least one frequency resource from the at least one second node. The method further comprises measuring, by the at least one third node, at least one of the at least one carrier phase of the at least one reference signal and the at least one carrier phase of the at least one pseudo-random code sequence on the at least one frequency resource, where the integer ambiguity is resolved using at least one of at least one carrier phase of the at least one reference signal and the at least one carrier phase of the at least one pseudo-random code sequence and transmitting, by the at least one third node, the at least one report comprising of the measurements to at least one of the at least one first node and the at least one second node to resolve the ambiguity.

In one aspect, when the at least one measurement comprise of the at least one carrier phase measurement over a plurality of frequency resources, the at least one report comprises of the at least one carrier phase difference between at least one pair of frequency resources, which is used to resolve the integer ambiguity.

In one embodiment, method for positioning a third node in a wireless communication system is described. The method comprises transmitting, by at least one first node, a capability request signal to at least one of at least one second node and the at least one third node. The method further comprises receiving, by the at least one first node, a capability response signal from at least one of the at least one second node and the at least one third node, where the capability-response signal comprises at least one of at least one frequency resource supported, at least one supported positioning method, support for carrier phase positioning, at least one measurement supported, and at least one granularity of performing the at least one measurement supported and at least one technique supported to resolve integer ambiguity. The method further comprises transmitting, by the at least one first node, an assistance information to at least one of the at least one second node and the at least one third node, where the assistance information comprises at least one of the at least one frequency resource to be used for the measurement, at least one measurement to be used, at least one granularity of performing the at least one measurement, at least one method supported to resolve integer-ambiguity, and at least one scheduling information and configuration information of at least one reference signal to be used for the measurement. The method further comprises receiving, by the at least one first node, at least one report comprising of at least one measurement from at least one of the at least one second node and the at least one third node.

In one aspect, where the at least one first node estimates a position of the at least one third node based on the at least one report received from at least one of the at least one second node and the at least one third node, the at least one measurement comprises at least one of at least one carrier phase measurement and at least one timing-based measurement of the at least one reference signal received and the at least one carrier phase measurement comprises of at least one carrier phase of at least one the received reference signal and at least one timestamp of the measurement.

In one aspect, the at least one first node is one of a positioning server, a location management function (LMF) server, an Access and Mobility Management Function (AMF) server, and sidelink positioning/ranging server. The at least one second node is one of a base station, a gNB, an eNB, a relay node, an integrated access and backhaul (IAB) node, a Vehicle-to-Everything (V2X) node, a Transmission Reception Point (TRP), anchor user equipment (UE) and a repeater in a cellular network. The at least one-third node is one of the target UE and Positioning reference unit (PRU), where the target UE is the node whose location is to be determined.

In one aspect, the method further comprises receiving, by the at least one first node, a positioning-request signal from at least one of the at least one first node and the at least one third node, to assist at least one of the at least one first node and the at least one third node in estimating the position of the at least one third node.

In one aspect, the method further comprises transmitting, by the at least one first node, assistance information-request to at least one of the at least one second node and the at least one third node.

In one aspect, the Antenna Reference Point comprises at least one of an antenna connector, transceiver array boundary connector, physical antenna, and central radiating region of antenna.

In one aspect, the timing-based measurements comprises at least one of second node Rx-Tx time difference where Rx-Tx time difference is the difference between the time at which at least one reference signal is received by the at least one of second node and the time at which a reference signal is transmitted by the same second node. The at least one third node Rx-Tx time difference is the difference between the time at which at least one reference signal is received by the at least one of third node and the time at which a reference signal is transmitted by the same third node. The relative time of arrival (RTOA) is the relative time taken by reference signal with respect to a reference time, to reach form one of the at least one third node to one of the at least one second node. The reference signal time difference (RSTD) is the difference between the relative time taken by reference signal to reach from the at least one second node to the at least one third node and the relative time taken by reference signal to reach from one of an another at least one second node to of the at least one third node.

In one aspect, when at least the at least one carrier phase measurement and timing-based measurements are supported, the capability information comprises at least one indication that at least one of the at least one second node and the at least one third node is capable of measuring and reporting the at least one carrier phase on the same reference signal resources as configured for timing-based measurements.

In one aspect, when at least the at least one carrier phase measurement and timing-based measurements are supported, the at least one first node receives an information comprises at least one indication from at least one of the at least one second node and the at least one third node indicating that the at least one carrier phase is measured on the same reference signal resources as configured for timing-based measurements.

In one aspect, when at least the at least one carrier phase measurement is supported, the capability information comprises at least one indication that the at least one carrier phase measurement is supported only for one of first path and multiple paths.

In one aspect, when the at least one carrier phase measurement is supported, the configuration signal comprises at least one indication that whether the at least one carrier phase measurement is to be reported for multiple paths or not.

In one aspect, the at least one carrier phase measurement for the first path is reported, and additionally the at least one carrier phase measurement for other multiple paths is reported if configured, where the first path is a line of sight (LoS) path.

In one aspect, the at least one reference signal is at least one of a sounding reference signal (SRS) and a positioning reference signal (PRS) and the configuration of the at least one reference signal comprises of the at least one of at least one reference signal resource and resource set.

In one aspect, the position estimated by the at least one first node is one of an absolute position with respect to global coordinates and a relative position with respect to the at least one first node or the at least one second node, and distance between the at least one second node, and the at least one third node.

In one aspect, the at least one carrier phase measurement received by one of the at least one first node is the difference between the phase of the received reference signal and the transmitted reference signal.

In one aspect, the at least one carrier phase measurement report received by the at least one first node comprises the at least one carrier phase difference estimated from the at least one carrier phase measurement on a plurality of received reference signals from a plurality of nodes.

In one aspect, the at least one carrier phase difference is the difference between the at least one carrier phase of the received reference signal form one of the at least one second node and the at least one carrier phase of the received reference signal from one of an another at least one second node.

In one aspect, the at least one first node receives the errors occurring at least one of the at least one second node and the at least one third node during the at least one carrier phase measurement, and where the errors include Transmission-Reception Points (TRP) synchronization error, Carrier Frequency Offset (CFO) error, antenna phase center offset, and oscillator drift.

In one aspect, the at least one first node receives the quality of the at least one carrier phase measurement and reports from at least one of the at least one second node and the at least one third node, where the quality of the at least one carrier phase measurement is based on a residual error in the phase based on the at least one carrier phase measured and reported.

In one aspect, the capability information further comprises at least one of frequency ranges supported, Positioning Frequency Layer (PFL), granularity of performing the at least one measurement at carrier level, subcarrier level, and both, or able to report the phase measurement of a virtual carrier, positioning methods supported comprising of at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method, capability of identifying and reporting the measurement for Line of Sight (LoS) and Non Line of Sight (NLoS) signals, and at least one technique supported to resolve integer ambiguity.

In one aspect, when the capability information comprises carrier phase positioning supported, the capability information further comprises a method to measure the at least one carrier phase and a Boolean indicator to indicate possibility of integer ambiguity resolution.

In one aspect, the assistance information further comprises at least one of a Physical Cell Identity (PCI), Global Cell Identity (GCI), Absolute Radio Frequency Channel Number (ARFCN), an ID of the at least one second node serving the at least one third node, timing information of the at least one second node serving the at least one third node, reference signal configuration of the at least one third node served by the at least one second node, SSB information of the at least one third node, Spatial direction information of the reference signal resources of the at least one third node served by the at least one second node, Geographical coordinates information of the at least one second node serving the at least one third node, node type, On-demand reference information, timing advance, at least one technique supported to resolve integer ambiguity, and integer ambiguity value.

In one aspect, the at least one carrier phase measurement is received over a plurality of frequency resources, the measurements reported further comprises at least one of the frequency resource values per carrier phase measurement, and the difference between the frequency resource values per carrier phase measurement and the frequency resource values comprise of at least one of a frequency carrier, a frequency subcarrier, a frequency band, and a frequency range.

In one aspect, the at least one report further comprises at least one of channel response in time and frequency, difference between two measurements in frequency domain for multiple frequency resources, frequency spacing between the at least one pair of frequency resources, distance between the at least one second node and the at least one third node, slope of the phase measurement when the measurement is performed over plurality of frequency resources.

In one aspect, the at least one carrier phase measurement corresponding to at least one of the first path and the additional paths comprises of at least one likelihood value, where the likelihood value is at least one of a soft value ranging between 0 and 1, and a hard value comprising of one of 0 and 1, where the likelihood values corresponds to likelihood whether the at least one carrier phase measurement is for one of LoS path and a NLoS path.

In one aspect, the at least one report further comprises signal strength corresponding to the measurement, errors in measurement, where the errors include clock error, Timing Error Group (TEG), and initial clock error, a New Radio Cell Global Identity (NCGI) and TRP ID of the measurement, the relative time of arrival (RToA), UL SRS-RSRP, UL SRS-RSRPP, multiple UL Angle of Arrival (AoA), SRS resource type, time stamp of the measurement, quality for each measurement, beam information for each measurement, Antenna Reference Point (ARP) ID of the measurement, the carrier phase over the at least one SRS, integer ambiguity value, carrier phases per antenna port, carrier phases per antenna panel, carrier phases per antenna element, and Phase Correction Offsets.

In one aspect, the integer ambiguity value denotes an integer number of wave cycles between the at least one second node and the at least one third node. The method further comprises at least one of determining, by the at least one first node, the integer ambiguity value based on the at least one report and transmitting, by the at least one first node, the integer ambiguity value to the at least one of the at least one second node and the at least one third node one of implicitly and explicitly.

In one aspect, the method further comprises configuring, by the at least one first node, at least one of the at least one second node and the at least one third node to measure on the at least one reference signal in a carrier frequency having wavelength greater than the actual distance between the at least one second node and the at least one third node. The method further comprises receiving the measurement, by the at least one first node, from at least one of the at least one second node and the at least one third node, the at least one carrier phase of the at least one reference signal in the single carrier frequency using a carrier of wavelength greater than the actual distance between the at least one second node and the at least one third node to resolve the ambiguity.

In one aspect, the method further comprises transmitting, by the at least one first node to at least one of the at least one second and the at least one third node a configuration information where the configuration information comprises measurement and reporting to be performed on at least one of at least one reference signal and at least one pseudo-random code sequence on the at least one frequency resource by the at least one of the at least one second and the at least one third node. The method further comprises receiving, by the at least one first node, at least one of the at least one carrier phase of the at least one reference signal and the at least one carrier phase of the at least one pseudo-random code sequence on the at least one frequency resource, where the integer ambiguity is resolved using at least one of the at least one carrier phase of the at least one reference signal and the at least one carrier phase of the at least one pseudo-random code sequence. The at least one pseudo-random code sequence is at least a physical random access channel (PRACH) preamble signal to resolve the ambiguity.

In one aspect, when the at least one measurement comprise of the at least one carrier phase measurement over a plurality of frequency resources, the at least one report comprises of the at least one carrier phase difference between at least one pair of frequency resources, which is used to resolve the integer ambiguity.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an architecture and interface for positioning in a wireless communication network, in accordance with prior art.

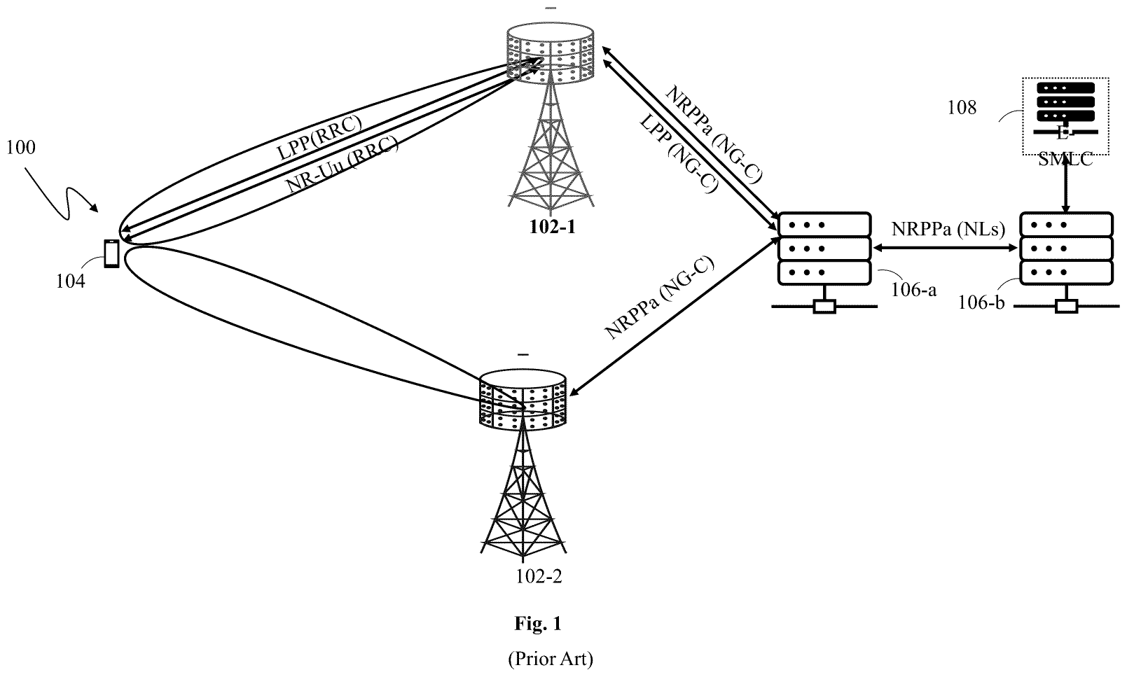

FIG. 2 illustrates positioning architecture for carrier phase-based positioning in Uplink (UL), in accordance with an embodiment of the present invention.

FIG. 3 illustrates positioning architecture for carrier phase-based positioning in Downlink (DL), in accordance with an embodiment of the present invention.

FIG. 4 illustrates a flow chart of a method positioning in a wireless communication system, in accordance with an embodiment of the present invention.

FIG. 5 illustrates a flow chart of a method positioning in a wireless communication system, in accordance with an embodiment of the present invention.

FIG. 6 illustrates a flow chart of a method positioning in a wireless communication system, in accordance with an embodiment of the present invention.

FIG. 7 illustrates estimation of carrier phase in a multi carrier method, in accordance with an embodiment of the present invention.

FIG. 8 illustrates positioning architecture for carrier phase-based positioning using Physical Resource Unit (PRU), in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof are intended to encompass both structural and functional equivalents thereof. Additionally, it is intended that such equivalents include both currently known equivalents as well as equivalents developed in the future (i.e., any elements developed that perform the same function, regardless of structure).

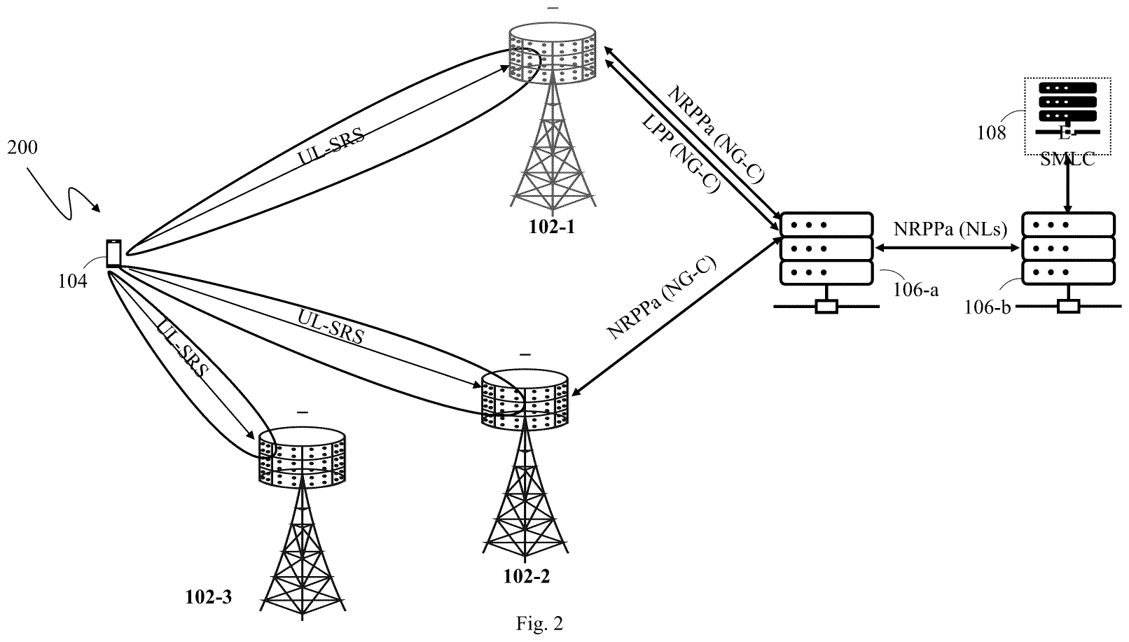

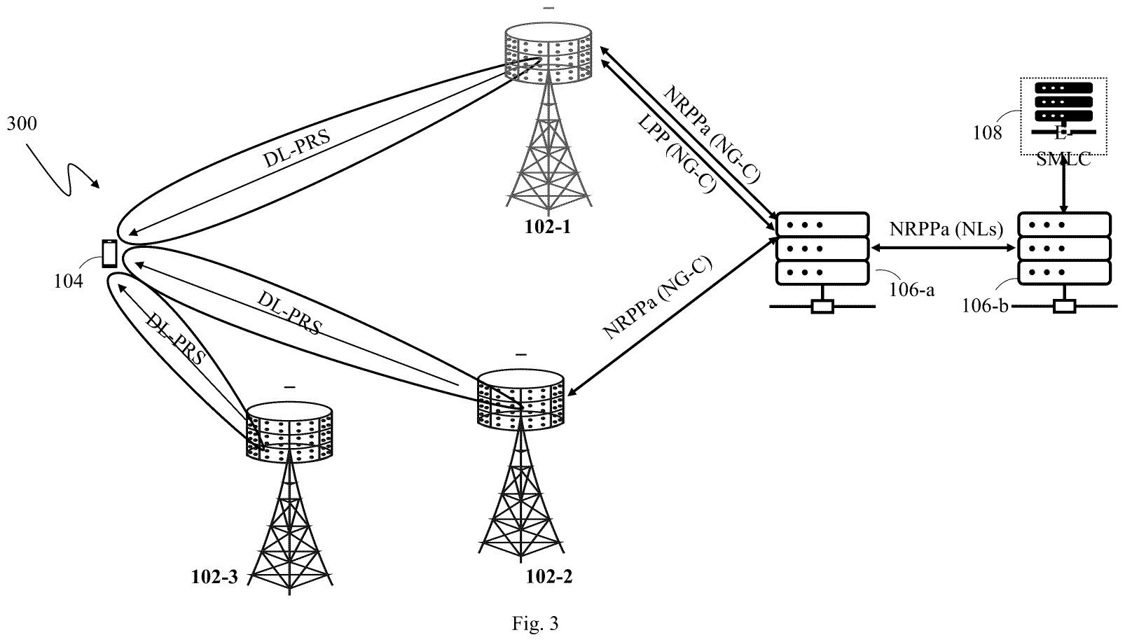

FIG. 2 illustrates positioning architecture for carrier phase-based positioning in Uplink (UL), in accordance with an embodiment of the present invention. FIG. 3 illustrates positioning architecture for carrier phase-based positioning in Downlink (DL), in accordance with an embodiment of the present invention. The wireless communication network 200/300 comprises Base Stations (BSs) or gNB or Transmission Reception Points (TRP), such as a serving TRP 102-1 and assisting TRPs 102-2 and 102-3 and target User Equipment (UE) 104. The serving TRP 102-1 and assisting TRPs 102-2 and 102-3 are cumulatively referred as a TRP 102 for the ease of labelling and explanation. The TRP 102 may communicate with each other for coordinating and communicating with the target UE 104. The target UE 104 may be either stationary or mobile and may be dispersed throughout the wireless communication network 200/300.

In 5G/LTE, the positioning of a target UE 104 may be triggered based on the request made to a Location Management Server (LMF) 106-b, which is a network entity of the 5G Core Network (CN) and interfaces with the Next Generation (NG) Radio Access Network (NG-RAN) via Access and Mobility Management Function (AMF) 106-a. This request may be generated by one of the networks nodes like the AMF 106-a, the LMF 106-b, the target UE 104, or any external agent 108. The LMF 106-b may interact with the AMF 106-a and NG-RAN via standard interface Network Links (NLs) and NRPPa (NLs-NG-C), respectively.

The present invention relates to a method for carrier phase-based positioning in a wireless communication system 200/300. Also, the present invention relates to signalling methods to enable carrier phase-based positioning in the wireless communication system 200/300. The present invention also provides methods to improve accuracy of measurement and mitigate error sources in carrier phase-based positioning in a wireless communication system 200/300.

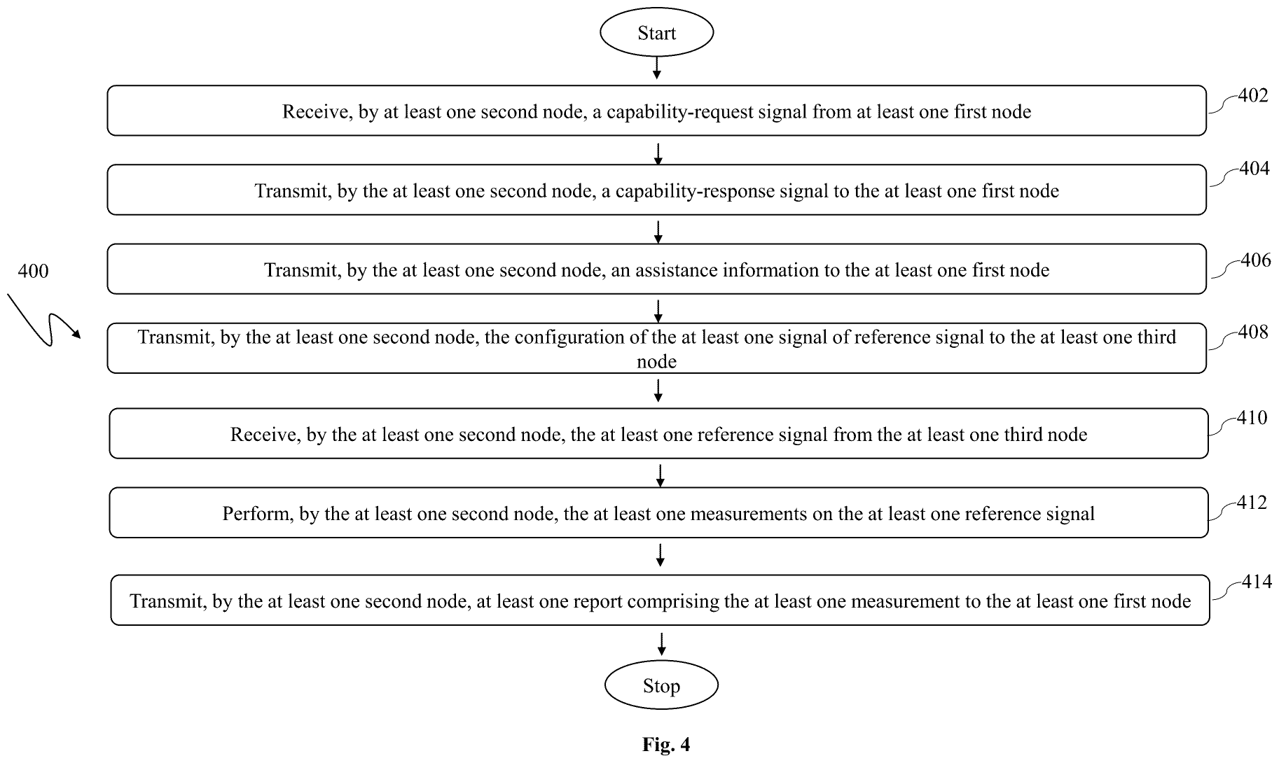

FIG. 4 illustrates a flow chart 400 of a method positioning in a wireless communication system, in accordance with an embodiment of the present invention. It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The TRP 102 may receive a capability-request signal from the AMF 106-a/LMF 106-b, at step 402. The TRP 102 may transmit a capability-response signal to the AMF 106-a/LMF 106-b, at step 404. The capability-response signal may comprise at least one of at least one frequency resource supported, at least one supported positioning method, support for carrier phase positioning, at least one measurement supported, at least one granularity of performing the at least one measurement supported and at least one technique supported to resolve integer ambiguity. The TRP 102 may transmit an assistance information to the AMF 106-a/LMF 106-b, at step 406. The assistance information may comprise at least one of the at least one frequency resource to be used for the measurement, the at least one measurement to be used, the at least one granularity of performing the at least one measurement, the at least one technique supported to resolve integer ambiguity, at least one reference signal configuration information and at least one scheduling information of at least one reference signal to be used for the measurement. The TRP 102 may transmit the configuration of the at least one reference signal to the target UE 104, at step 408. The TRP 102 may receive the at least one reference signal from the target UE 104, at step 410. The TRP 102 may perform at least one measurement on the at least one reference signal, at step 412. The at least one measurement may be with respect to Antenna Reference Point (ARP). The TRP 102 may transmit at least one report comprising the at least one measurement to the AMF 106-a/LMF 106-b, at step 414. The AMF 106-a/LMF 106-b may estimate a position of the target UE 104 based on the at least one report received from the TRP 102. The at least one measurement may comprise at least one of at least one carrier phase measurement and at least one timing-based measurement of the at least one reference signal received from the TRP 102 and at least one timing-based measurement. The at least one carrier phase of at least one the received reference signal may comprise of at least one carrier phase and at least one timestamp of the measurement.

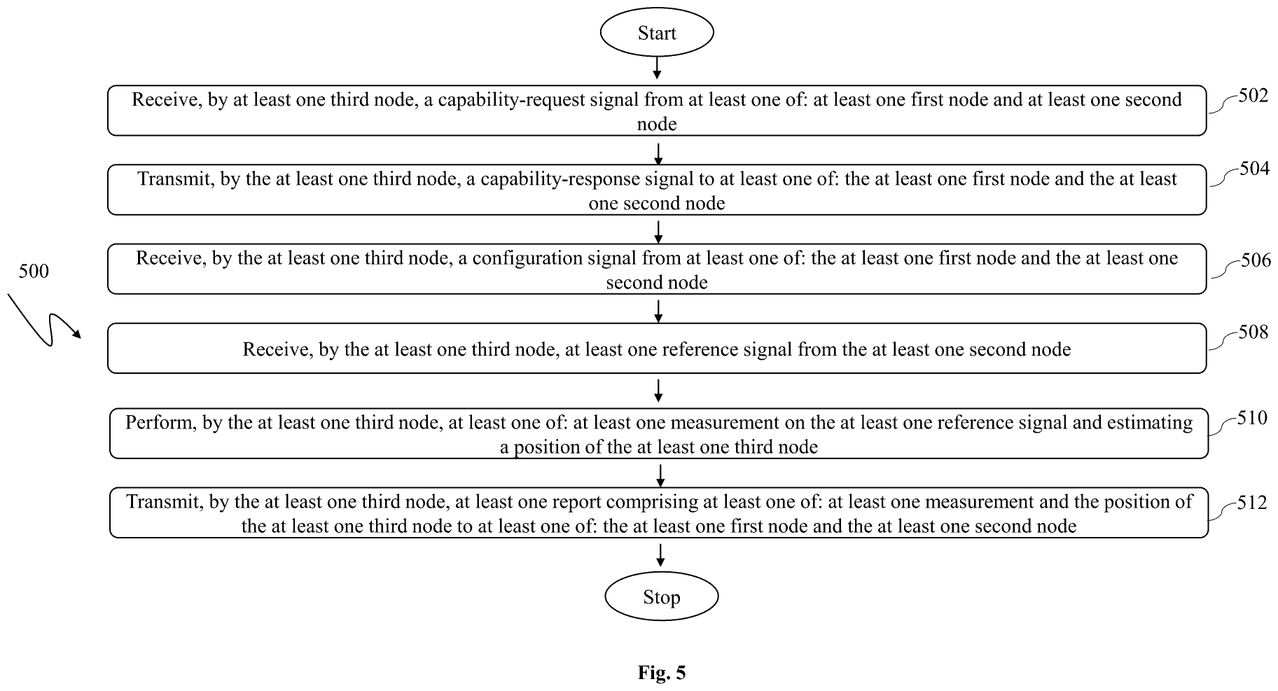

FIG. 5 illustrates a flow chart 500 of a method positioning in a wireless communication system, in accordance with an embodiment of the present invention. It should also be noted that in some alternative implementations, the functions noted in the blocks may occur out of the order noted in the drawings. For example, two blocks shown in succession in FIG. 5 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The target UE 104 may receive a capability-request signal from at least one of the AMF 106-a/LMF 106-b and the TRP 102, at step 502. The target UE 104 may transmit a capability-response signal to at least one of the AMF 106-a/LMF 106-b and the TRP 102, at step 504. The capability-response signal may comprise at least one of at least one frequency resource supported, at least one supported positioning method, support for carrier phase positioning, at least one measurement supported, at least one granularity of performing the at least one measurement supported, at least one technique supported to resolve integer ambiguity. The target UE 104 may receive a configuration signal from at least one of the AMF 106-a/LMF 106-b and the TRP 102, at step 506. The configuration signal may comprise at least one of the at least one frequency resource to be used for the measurement, at least one measurement to be used, at least one granularity of performing the at least one measurement, at least one method supported to resolve integer-ambiguity, and at least one scheduling information and configuration information of the at least one reference signal to be used for the measurement. The target UE 104 may receive at least one reference signal from the TRP 102, at step 508. The target UE 104 may perform at least one of at least one measurement on the at least one reference signal and estimating a position of the target UE 104, at step 510. The at least one measurement may be with respect to the ARP. The target UE 104 may transmit at least one report comprising at least one of at least one measurement and the position of the target UE 104 to at least one of the AMF 106-a/LMF 106-b and the TRP 102, at step 512. The at least one measurement may comprise at least one of at least one carrier phase measurement and at least one timing-based measurement of the at least one reference signal received from the TRP 102. The at least one carrier phase measurement may comprise of at least one carrier phase and at least one timestamp of the measurement.

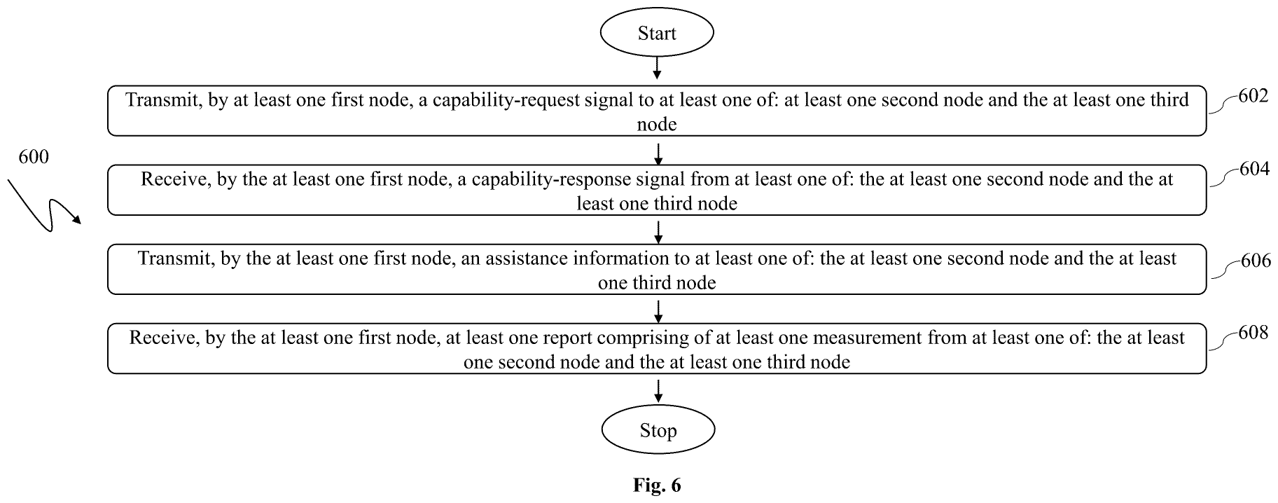

FIG. 6 illustrates a flow chart 600 of a method positioning in a wireless communication system, in accordance with an embodiment of the present invention. It should also be noted that in some alternative implementations, the functions noted in the blocks may occur out of the order noted in the drawings. For example, two blocks shown in succession in FIG. 6 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The AMF 106-a/LMF 106-b may transmit a capability-request signal to at least one of the TRP 102 and the target UE 104, at step 602. The AMF 106-a/LMF 106-b may receive a capability-response signal from at least one of the TRP 102 and the target UE 104, at step 604. The capability-response signal may comprise at least one of at least one frequency resource supported, at least one supported positioning method, support for carrier phase positioning, at least one measurement supported, and at least one granularity of performing the at least one measurement supported and at least one technique supported to resolve integer ambiguity. The AMF 106-a/LMF 106-b may transmit an assistance information to at least one of the TRP 102 and the target UE 104, at step 606. The assistance information may comprise at least one of the at least one frequency resource to be used for the measurement, at least one measurement to be used, at least one granularity of performing the at least one measurement, at least one method supported to resolve integer-ambiguity, and at least one scheduling information and configuration information of at least one reference signal to be used for the measurement. The AMF 106-a/LMF 106-b may receive at least one report comprising of at least one measurement from at least one of the TRP 102 and the target UE 104, at step 608. The AMF 106-a/LMF 106-b may estimate a position of the target UE 104 based on the at least one report received from at least one of the TRP 102 and the target UE 104. The at least one measurement may comprise at least one of at least one carrier phase measurement and at least one timing-based measurement of the at least one reference signal received from the target UE 104. The at least one carrier phase measurement may comprise of at least one carrier phase and at least one timestamp of the measurement.

When at least the at least one carrier phase measurement and timing-based measurements are supported, the capability-response signal may comprise at least one indication that the target UE 104 is capable of measuring and reporting the at least one carrier phase on same reference signal resources as configured for timing-based measurements. When at least the at least one carrier phase measurement and timing-based measurements are supported, the configuration signal may comprise at least one indication for the target UE 104 to report the at least one carrier phase on same reference signal resources as configured for timing-based measurements. When at least the at least one carrier phase measurement is supported, the capability-response signal may comprise at least one indication that the at least one carrier phase measurement is supported only for first path or multiple paths. When the at least one carrier phase measurement is supported, the configuration signal may comprise at least one indication that whether the at least one carrier phase measurement is to be reported for multiple paths or not. The at least one carrier phase measurement for the first path may be reported, and additionally the at least one carrier phase measurement for other multiple paths may be reported if configured, where the first path is a line of sight (LoS) path.

The TRP 102 may receive a positioning-request signal from at least one of the AMF 106-a/LMF 106-b and the target UE 104, to assist at least one of the AMF 106-a/LMF 106-b and the target UE 104 in estimating the position of the target UE 104. The assistance information may be transmitted by the TRP 102 to the AMF 106-a/LMF 106-b upon receiving the assistance information-request from the AMF 106-a/LMF 106-b. The Antenna Reference Point (ARP) may comprise at least one of an antenna connector, transceiver array boundary connector, physical antenna, and central radiating region of antenna.

The timing-based measurements may comprise at least one of the target UE 104 Receiver-Transmitter (Rx-Tx) time difference, the AMF 106-a/LMF 106-b Rx-Tx time difference, Relative Time of Arrival (RTOA), and Reference Signal Time Difference (RSTD). The target UE 104 Rx-Tx time difference may be the difference between the time at which the at least one reference signal is received by the TRP 102 and the time at which a reference signal is transmitted by the TRP 102. The AMF 106-a/LMF 106-b Rx-Tx time difference may be the difference between the time at which the at least one reference signal is received by the target UE 104 and the time at which a reference signal is transmitted by the target UE 104. The RTOA may be the relative time taken by reference signal with respect to a reference time, to reach from the target UE 104 to the TRP 102. The RSTD may be the difference between the relative time taken by reference signal to reach from the TRP 102 to the target UE 104 and the relative time taken by reference signal to reach from one of an another TRP 102 to of the same target UE 104.

In UL carrier phase-based positioning, the AMF 106-a/LMF 106-b may gather the at least one PRS or any other UL RS configuration set from the TRP 102 additionally TRP 102 may configure the target UE 104 to send the at least one PRS for positioning. The TRP 102 may receive the at least one PRS and may measure the carrier phase by estimating a first path of arrival of the at least one PRS over a channel.

In DL carrier phase-based positioning, the AMF 106-a/LMF 106-b may configure the TRP 102 to transmit one or more PRS resource set containing one or more PRS resources per beam. The target UE will be configured to receive one or more PRS signals. The AMF 106-a/LMF 106-b may configure the PRS resource set configurations to the target UE 104 as per the configuration set provided by the TRP 102 over NRPPa signals. The configuration of PRS may be in the time-frequency grid of the OFDM signal. The target UE 104 may receive at least one PRS resources and may estimate the channel over the PRS resources. If the at least one PRS is transmitted as a full stagger pattern, then the received PRS may be concatenated over the full band of transmission, and the channel estimation may be performed over received concatenated PRS signals, and the first path of the arrival of the signal may be detected. The first path may be the LoS path, the phase of the first path may be measured, and the distance between the TRP 102 and the target UE 104 may be measured using the following equations.

The xₖ^{A} reference signal (PRS) may be transmitted in downlink over the subcarrier of OFDM wave at some time instance t and H(k) may be the channel response for the carriers. The target UE 104 may receive the signal y_{A}(τ−τ_{A}) with some propagation delay τ_{A} as given by Eq. (1):

y_{A}(t−τ_{A})=ΣₖH(k)xₖ^{A} exp^{-j(ω}^{_{c}}^{+ω}^{ₖ}^{)τ}^{_{A}}^{+j(ϕ}^{_{A}}^{-ϕ}^{ᵣ}⁾ (1)

The received passband signal may be down converted to baseband signal which gives us r_{A}(τ−τ_{A}), as given by Eq. (2) and (3):

r_{A}(τ−τ_{A})=ΣₖH(k)xₖ^{A} exp^{j(ωt)}exp−^{-j(ω}^{_{c}}^{+ω}^{ₖ}^{)τ}^{_{A}}^{+j(ϕ}^{_{A}}^{-ϕ}^{ᵣ}⁾ (2)

r_{A}(τ−τ_{A})=ΣₖH(k)xₖ^{A} exp^{-j(ω}^{_{c}}^{+ω}^{ₖ}^{)τ}^{_{A}}+exp^{j(ϕ}^{_{A}}^{-ϕ}^{ᵣ}⁾ (3)

This time domain signal r_{A}(τ−τ_{A}) may be converted into frequency domain signal R_{A}(k) as given by Eq. (4):

R_{A}(k)=H(k)Xₖ^{A} exp^{-j(ω}^{_{c}}^{+ω}^{ₖ}^{)τ}^{_{A}} exp^{j(ϕ}^{ₑ}) (4)

wherein ϕₑ=ϕ_{A}−ϕᵣ may be an initial phase error due to clock synchronization at the receiver.

The target UE 104 may measure the phase over this frequency domain signal which is ∠R_{A}(k) as given by Eq. (5) and (6):

∠R_{A}(k)=−(ω_{c}+ωₖ)τ_{A}+(ϕₑ)−2πN_{IA} (5)

≈∠R_{A}=−(ω_{c})τ_{A}+(ϕₑ)2πN_{IA} (6)

wherein H(k) may be estimated as Xₖ^{A}, ω, may be a lower frequency, ωₖ may be a higher frequency, τ_{A} may be the propagation delay, ϕₑ may be the initial phase error due to clock synchronization and N_{IA} may be an integer number of wave cycles traveled between the TRP 102 and the target UE 104.

Using the phase measurement, the propagation delay experienced by the signal τ_{A} or distance traveled by the signal which is D may be estimated. If the measurement is done over LOS signal the accurate distance in terms of time or the actual distance between the TRP 102 and the target UE 104 may be estimated with the help of Eq. (7), (8) and (9):

$$\begin{matrix}D = \frac{λ ( 2 π {N}_{IA} + ∠ {R}_{A} ( k ) - {ϕ}_{e} )}{2 π} & ( 7 ) \\ D = λ {N}_{IA} + \frac{λ∠ {R}_{A} ( k )}{2 π} - \frac{{ϕ}_{e} λ}{2 π} & ( 8 ) \\ {τ}_{A} = \vert \frac{2 π {N}_{IA} + ∠ {R}_{A} ( k ) - {ϕ}_{e}}{{ω}_{c}} \vert & ( 9 )\end{matrix}$$

wherein λ may be a wavelength between the TRP 102 and the target UE 104.

The carrier phase-based positioning may be classified as UE-based and UE-assisted depending on the node estimating the position of the target UE 104. In the case of UE-based positioning, the target UE 104 may estimate the carrier phase and use this measurement along with assisting data provided by the AMF 106-a/LMF 106-b to measure its final position of itself. This position may be absolute position with respect to global coordinates, relative position with respect to any other reference node, or ranging between the TRP 102 and the target UE 104, one being the target UE 104. In case of UE assisted method, the target UE 104 or the TRP 102 may provide the carrier phase measurements to the AMF 106-a/LMF 106-b or the TRP 102. The AMF 106-a/LMF 106-b or the TRP 102 may use these measurements along with assisting information available to get the final positioning of the target UE 104.

In one aspect, the carrier phase measurements may be performed on the single carrier frequency, and the measured phase may be the function of the distance between the TRP 102 and the target UE 104. At the target UE 104, the phase difference between the transmitted PRS and the received PRS may be estimated, but the target UE 104 may not get the information about the multiple cycles of wavelength missed between the TRP 102 and the target UE 104. This may be known as integer ambiguity. The integer ambiguity may be due to the fact that the carrier phase may be rounded off at every wavelength distance. Therefore, as carrier frequency increases, the wavelength decreases, and so as the resolvable distance between the TRP 102 and the target UE 104. In the single carrier method, the integer ambiguity may be informed to the target UE 104 implicitly or explicitly. In one direct approach, a carrier with a very long wavelength such that the wavelength is longer than the actual distance between the TRP 102 and the target UE 104 may be used to do the carrier phase measurement. Recursively, the carrier with the higher frequency may be used to further improve the accuracy.

In one embodiment, a special signal may be generated at the TRP 102 for positioning, for example, a pseudo-random code sequence may be modulated on the carrier frequency. This code sequence may have higher periodicity. The TRP 102 may transmit this signal. The target UE 104 may calculate the phase difference of the received signal with respect to the reference signal generated locally. The phase measurement of the code and phase measurement of the carrier may be combined to get the accurate distance estimate. The phase difference of the code may be helpful in finding the integer ambiguity. This may be possible in the 5G framework with the help of the PRACH signal in the UL direction. PRACH signal may be transmitted in the uplink direction where the TRP 102 does the measurement on the received signal. The measuring entity may calculate the timing advance using the PRACH signal, and this information may be combined with the phase measurement of the carrier to get the distance estimate. This method of using the code sequence to resolve the integer ambiguity may be known as pseudo-range integer ambiguity resolution. In DL, the at least one PRS sequence may be modified to have longer length in time and transmitted to measure the time of arrival to find integer ambiguity.

In one embodiment, the integer ambiguity may be informed to the position estimating entity such as the AMF 106-a/LMF 106-b, the TRP 102 and the target UE 104. In the 5G framework, Reference-Signal-Time-Difference (RSTD), Reference Signal Time Difference on Arrival (RToA), Rx-Tx time difference, and timing advance measurement already exists. The position estimating entity may exploit these measurements to resolve integer ambiguity. The position estimating entity may request the network to report these measurements along with the carrier phase measurement. The position estimating entity may use these timing measurements to resolve the integer ambiguity and carrier phase measurement may be used to further achieve the distance estimate with greater accuracy. The position estimating entity may use prior network information for understanding the coarse position of the target UE 104 based on previously performed measurements and use the carrier phase measurement to refine the accuracy of the position estimate.

In one aspect, the phase measurements may be performed on multiple carrier frequencies and the measured phase may be used to estimate the distance the TRP 102 and the target UE 104. In the 5G framework, the phase measurements may be done at the different carrier frequencies. The operating frequency range of the 5G may be very wide, for example, FR1 frequency range starts from 450 MHz and goes up to 6.5 GHz, and FR2 frequency range starts at 27.5 GHz up to 52.6 GHz. Apart from these frequencies, the 5G may use OFDM wave where a frequency band consisted of multiple sub-carriers are transmitted on the same carrier frequency, there might be different subcarrier groups with same or different subcarrier spacing (numerology) grouped together within the same band which is called frequency layer. 5G may also support operation on different frequency bands with different bandwidths. The carrier phase measurements may be reported at one of these different frequency gratuities or at more than one of these different frequency granularities.

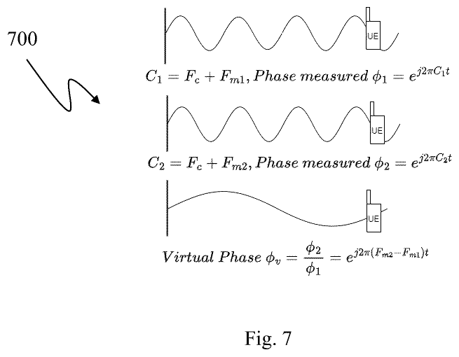

FIG. 7 illustrates estimation of carrier phase in a multi carrier method, in accordance with an embodiment of the present invention. As shown in the FIG. 7, the phase of two adjacent carriers may be measured and combining these two measurements may yield a new carrier wave having a longer wavelength. The new carrier wave may resolve the integer ambiguity when the wavelength of the new carrier wave is greater than the distance between the TRP 102 and the target UE 104. The phase measured over the new is newly carrier wave may provide the distance estimate directly.

In one embodiment, the TRP 102 may configure the target UE 104 with multiple carrier frequencies from longer wavelength to shorter wavelength to resolve integer ambiguity. The TRP 102 may decide longer wavelength carrier to be function of maximum distance over which positioning is expected to perform integer ambiguity resolution. The TRP 102 may decide shorter wavelength carrier based on positioning resolution expected to achieve. The longer wavelength carrier may give carrier phase measurement which will be used for estimating integer ambiguity and shorter wavelength carrier may give the desired positioning with expected resolution using the estimated integer ambiguity.

In one embodiment, sub carrier may be used to resolve the integer ambiguity. The virtual carrier wave method may be used by the target UE 104 or by the position estimating entity. The carrier phase may be measured over each sub-carrier. The virtual carrier of longer wavelength may be obtained by subtracting two sub carriers having a frequency spacing are placed at predefined distance. The TRP 102 may configure the target UE 104 with a predefined frequency distance, which may be a function of the approximate distance between the TRP 102 and the target UE 104. The target UE 104 may be configured with multiple frequency spacing. Higher the spacing may be more agnostic to integer ambiguity and lesser the spacing may be more prune to integer ambiguity error. Therefore at least one frequency spacing may be selected to get carrier phase without integer ambiguity. This carrier phase may be used to measure integer ambiguity using second frequency spacing based carrier phase. Another frequency spacing may be lesser than the first frequency spacing and may provide more accurate positioning resolution.

In one embodiment, carrier phase may be measured using slope estimated over the phase response of the channel across the sub-carriers. In case of strong line of sight between the TRP 102 and the target UE 104, the phase response may be linear across the sub-carrier index. In this method, calculated slope of phase response may be used to reconstruct the phase response of channel assuming initial phase is zero. In order to find longer wavelength virtual carrier, a suitable m may be chosen which will generate a virtual sub-carrier which is ‘m’ times sub carrier spacing. Further to estimate the phase of virtual subcarrier, phase difference from 1^{st} subcarrier to the m^{th} subcarrier may be estimated. This phase difference may be used to estimate the time of arrival between the transmitting node and receiving node. Further it can be used to estimate the location of the target UE 104 knowing the location of the TRP 102. This method has advantage of less overhead of signaling as in case of UE assisted positioning it is necessary to report back only slope of the phase response of channel observed at the target UE 104.

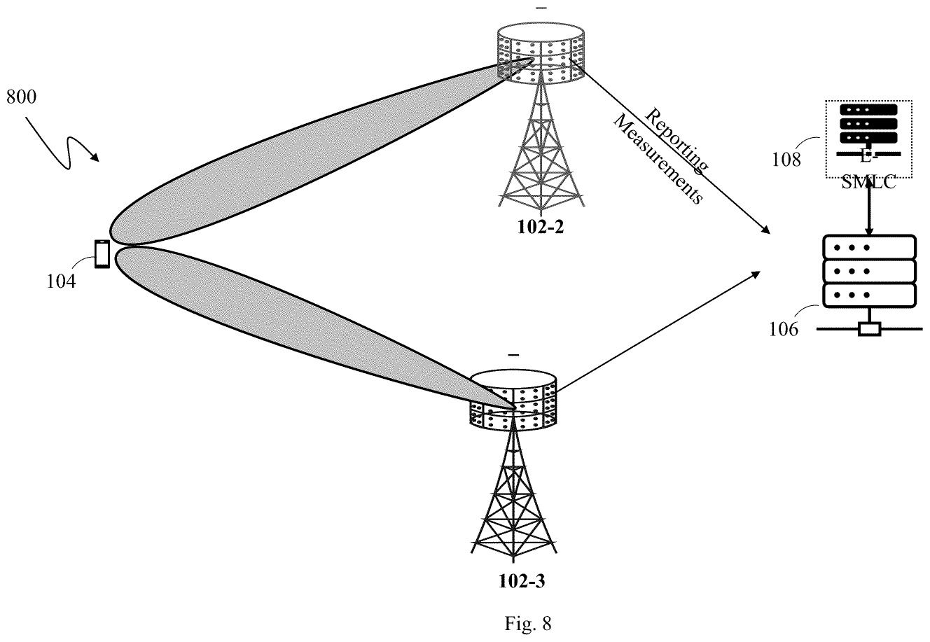

FIG. 8 illustrates positioning architecture for carrier phase-based positioning using Physical Resource Unit (PRU) 104, in accordance with an embodiment of the present invention. The carrier phase may suffer with different impairments such as TRP synchronization error, CFO in the receiver, antenna phase center offset, oscillator drift etc. These error in the TRP may be effectively calibrated using the PRU 104. The PRU 104 may be a positioning reference unit or the target UE 104 or any other node whose location is known with sufficiently accurately and may be capable of performing positioning measurements. The PRU 104 may be configured to measure the positioning measurement and may report back to measuring entity (either the AMF 106-a/LMF 106-b or the TRP 102). Upon receiving these measurements, measuring entity may use the location of the PRU 104 and measurement to estimate the residual error in the phase. Hypothesizing that the error is introduced due to TRP 102, this error may be used to correct measurement while performing positioning of the target UE 104 using carrier phase measurements. As illustrated in FIG. 7, the TRP 102 may transmit the at least one PRS to the PRU 104. The PRU 104 may perform the measurements and report back to the AMF 106-a/LMF 106-b to estimate the error using location of the PRU 104 and the reported measurements.

The signaling in carrier phase positioning methods may broadly categorized as a standalone positioning method and as a non-standalone positioning method where the carrier phase as an additional measurement in existing positioning methods.

In one aspect, the carrier phase measurement may be viewed as the standalone positioning method. The AMF 106-a/LMF 106-b may estimate the location or position of the target UE 104 based on the carrier phase measurement reported by the TRP 102 or by the target UE 104. There may be two possible entities in the system capable of estimating the location the target UE 104, namely, the positioning server which could be any network node capable of estimating position, for example, the AMF 106-a/LMF 106-b, and the target UE 104 itself. The location estimating entity AMF 106-a/LMF 106-b should know the capabilities of the system prior to commencing the procedure of positioning and localization. The capability exchange between the AMF 106-a/LMF 106-b and the system may happen on a demand basis, or the capability information may be shared unsolicited. In the case of the AMF 106-a/LMF 106-b estimates the location of the target UE 104, the AMF 106-a/LMF 106-b may be aware of the capability of the TRP 102 and the target UE 104 involved in positioning. The capability information may contain information like the frequency range supported by the TRP 102 and the target UE 104 (FR1, FR2, or both FR1 and FR2, and positioning frequency layer (PFL)), the capability of performing (or reporting) the measurement at the RF carrier level, at the sub-carrier level, at both RF carrier level and subcarrier, with respect to the ARP, or able to report the phase measurement of the virtual carrier, the positioning methods supported by the TRP 102 and the target UE 104 involved in positioning, for example,(carrier phase, DL-TDoA, UL-TDoA, Multi-RTT, DL-AoD, UL-AoA, E-CID), the method supported for integer ambiguity resolution, whether the measuring node supports the pseudo-range method or virtual carrier method or supports the use of the existing measurements like RSTD, RToA, and Rx-Tx time difference, the capability of identifying the LoS and non-LoS signal, and if supported, then the measurements corresponding to the LoS and non-LoS signal are supported or not supported. Further, based on the capability information, the AMF 106-a/LMF 106-b may choose the optimal resources and the measurements to estimate the location of the target UE 104. The information exchanges may be carried out between the AMF 106-a/LMF 106-b, the TRP 102 and the target UE 104.

When the TRP 102 is acting as a measuring entity, the AMF 106-a/LMF 106-b may request the TRP 102 to perform the carrier phase measurements for estimating the position of the target UE 104. After receiving the measurement request, the TRP 102 may perform the additional information exchange with the target UE 104 to enable the measurements. The TRP 102 may inform the target UE 104 about the uplink signal and the time and frequency resources to be used to enable the measurements at the TRP 102. This information may contain SRS and PRACH configuration (such as periodicity, timing gap, resources, if the signal is unicast or broadcast, etc.) to be used for uplink transmission of the signals. This information may also be conveyed to the AMF 106-a/LMF 106-b by the TRP 102. The AMF 106-a/LMF 106-b may inform the TRP 102 about the uplink positioning method and corresponding measurements to be reported based on the information received from the target UE 104. Along with the measurement request, the AMF 106-a/LMF 106-b may provide detailed information to the TRP 102 regarding the measurement to be taken (or reported). This information contains whether the measurements are to be performed (or reported) at the RF carrier level, at the sub-carrier level, or at both the RF carrier level and subcarrier, with respect to the ARP, or reporting the phase of the virtual carrier or some combination of all the listed measurements granularities.

In the case where multiple frequency measurements may be used and if the information regarding the gap between the frequency measurements is not informed to the TRP 102 explicitly, then timing advance may be used to decide the gap between the frequency measurement. The AMF 106-a/LMF 106-b may inform the TRP 102 regarding the measurement and the nature or type of the measurement that needs to be reported. The TRP 102 may convey the gap between the two observations in the frequency domain if the measurement is done on more than one frequency. The TRP 102 may report the distance estimated between the TRP 102 and the target UE 104 in terms of actual distance or in terms of time. If the measurement is done on the subcarrier level, then the TRP 102 may report the slope of the phase measurements across the subcarrier of the OFDM wave to the AMF 106-a/LMF 106-b. The TRP 102 may report number of each type of measurement being reported to the AMF 106-a/LMF 106-b. The AMF 106-a/LMF 106-b may configure the TRP 102 to report the measurements corresponding to LoS and non-LoS signals i.e., soft value or hard value. The hard value may be either 1 or 0, whereas soft value may be in the range of 0 to 1 as a likelihood of measurement being from LoS or non-LoS link may also conveyed with every measurement report. Along with the LoS or non-LoS likelihood, the TRP 102 may also be configured to report the signal power or signal strength (e.g., Reference Signal Received Power (RSRP) or Reference Power Received Quality (RSRQ)) corresponding to the measurement. Some information regarding measuring entities like TRP 102 may also be required by the AMF 106-a/LMF 106-b. The TRP 102 may report information containing the identification information (TRP ID, Cell ID, Resource ID) about the TRP 102, the geographical location of the TRP 102, and the configuration information of the signals to be measured to the AMF 106-a/LMF 106-b. The TRP 102 may report configuration information associating the measured signal (such as SRS/PRACH configuration) with the target UE 104 to the AMF 106-a/LMF 106-b.

After completing the exchange of assistance information and setting up the context, the target UE 104 may commence the transmission of the UL signal, and the configured TRP 102 may perform the measurements. After taking the measurements, the TRP 102 may report these measurements to the AMF 106-a/LMF 106-b in a message format. The message to the AMF 106-a/LMF 106-b may contain information to associate the measurement being reported by the TRP 102, the resources used by the target UE 104 to transmit the signal, such as SRS/PRACH configuration, the receiver beam information, the cell ID, TRP ID, and the nature or type of the measurement. The nature or type of measurement may contain one or more of the phase measurement, the channel response in time or in frequency, the gap between the two observations in the frequency domain if the measurement is done on more than one frequency, the distance estimated between the TRP 102 and the target UE 104 in terms to actual distance or in terms of time, the slope of the phase measurements across the subcarrier of the OFDM wave if the measurement is done on the subcarrier level, the number of each type of measurement being reported, measurements corresponding to the LoS and non-LoS signals, and the measurements corresponding to the signal power or signal strength (e.g., RSRP or RSRQ).

The TRP 102 may report additional information corresponding to the measurement to the AMF 106-a/LMF 106-b. The additional information may comprise information regarding the frequency resources used for the measurement, whether the reported measurement is taken on the RF carrier or on the subcarrier, if the measurement is taken on both the RF carrier and the subcarrier, then the report may map these measurements to the proper carrier and subcarriers, if the measurement is taken with respect to the specific antenna reference point of the TRP 102 or of the target UE 104, then reported measurement may be mapped with the corresponding antennal reference point, the time stamp of every measurement. Further, if the virtual carrier-based method is used, then the virtual carrier wavelength used in the measurement may be reported along with the measurements. The TRP 102 may report error sources that might not be considered in the measurement, for example, UE clock error, timing error group (TEG), and initial clock error.

The target UE 104 may receive measurement request from the AMF 106-a/LMF 106-b for estimating position of the target UE 104. The target UE 104 may receive configuration information of at least one reference signal resource set from the TRP 102. The at least one reference signal resource set may comprise at least one reference signal resource per beam. The target UE 104 may receive at least one Positioning Reference Signal (PRS) from the TRP 102. The TRP 102 may receive measurement parameters from the AMF 106-a/LMF 106-b. The parameters may comprise uplink positioning method, carrier level measurement, and phase measurement, distance between the TRP 102 and the target UE 104. The target UE 104 may report the measurement to the TRP 102.

The TRP 102 may forward the measurement to the AMF 106-a/LMF 106-b to allow the AMF 106-a/LMF 106-b to estimate the position of the target UE 104.

When the target UE 104 acts as a measuring entity, the AMF 106-a/LMF 106-b may request the TRP 102 to assist in downlink positioning. The TRP 102 may provide the configuration information to the target UE 104 or the AMF 106-a/LMF 106-b about the downlink signal and the time and frequency resources to be used to enable the measurements at the target UE 104. The configuration information may contain PRS configuration (such as periodicity, timing gap, resources, if the signal is unicasted or broadcasted, etc.) to be used for downlink transmission of the signals. The TRP 102 may report configuration information regarding the downlink signal and the resources to the AMF 106-a/LMF 106-b used for the measurement by the target UE 104. The AMF 106-a/LMF 106-b may provide information regarding the measurement to be performed (or be reported) is provided to the target UE 104. The information may contain whether the measurement to be performed (or reported) at the RF carrier level, at the sub-carrier level, at both the RF carrier level and subcarrier, with respect to the ARP, or reporting the phase of virtual carrier, or some combination of all the listed measurements granularities. The AMF 106-a/LMF 106-b may provide information to the target UE 104 regarding the nature or type of measurement that needs to be reported.

The target UE 104 may convey the gap between the two observations in the frequency domain if the measurement is done on more than one frequency. The target UE 104 may report the distance estimated between the TRP 102 and the target UE 104 in terms of actual distance or in terms of time. If the measurement is done on the subcarrier level, then the target UE 104 may report the slope of the phase measurements across the subcarrier of the OFDM wave to the AMF 106-a/LMF 106-b. The target UE 104 may report number of each type of measurement being reported to the AMF 106-a/LMF 106-b. The AMF 106-a/LMF 106-b may configure the target UE 104 to report the measurements corresponding to LoS and non-LoS signals i.e., soft value or hard value. The hard value may be either 1 or 0, whereas soft value may be in the range of 0 to 1 as a likelihood of measurement being from LoS or non-LoS link may also conveyed with every measurement report. Along with the LoS or non-LoS likelihood, the target UE 104 may also be configured to report the signal power or signal strength (e.g., Reference Signal Received Power (RSRP) or Reference Power Received Quality (RSRQ)) corresponding to the measurement. Some information regarding measuring entities like TRP 102 may also be required by the AMF 106-a/LMF 106-b. The target UE 104 may report information containing the identification information (TRP ID, Cell ID, Resource ID) about the TRP 102, the geographical location of the TRP 102, and the configuration information of the signals to be measured to the AMF 106-a/LMF 106-b. The target UE 104 may report configuration information associating the measured signal (such as SRS/PRACH configuration) with the TRP 102 to the AMF 106-a/LMF 106-b.

After completing the exchange of assistance information and setting up the context, the TRP 102 may commence the transmission of the DL signal, and the configured target UE 104 may perform the measurements. After taking the measurements, the target UE 104 may report these measurements to the AMF 106-a/LMF 106-b in a message format. The message to the AMF 106-a/LMF 106-b may contain information to associate the measurement being reported by the target UE 104 and the nature or type of the measurement. The nature or type of measurement may contain one or more of the phase measurement, the channel response in time or in frequency, the gap between the two observations in the frequency domain if the measurement is done on more than one frequency, the distance estimated between the TRP 102 and the target UE 104 in terms to actual distance or in terms of time, the slope of the phase measurements across the subcarrier of the OFDM wave if the measurement is done on the subcarrier level, the number of each type of measurement being reported, measurements corresponding to the LoS and non-LoS signals, and the measurements corresponding to the signal power or signal strength (e.g., RSRP or RSRQ).

The target UE 104 may report additional information corresponding to the measurement to the AMF 106-a/LMF 106-b. The additional information may comprise information regarding the frequency resources used for the measurement, whether the reported measurement is taken on the RF carrier or on the subcarrier, if the measurement is taken on both the RF carrier and the subcarrier, then the report may map these measurements to the proper carrier and subcarriers, if the measurement is taken with respect to the specific antenna reference point of the TRP 102 or of the target UE 104, then reported measurement may be mapped with the corresponding antennal reference point, the time stamp of every measurement. Further, if the virtual carrier-based method is used, then the virtual carrier wavelength used in the measurement may be reported along with the measurements. The target UE 104 may report error sources that might not be considered in the measurement, for example, UE clock error, timing error group (TEG), and initial clock error.

In one embodiment, the target UE 104 may estimate the location or position of the target UE 104 based on the carrier phase measurement performed by the target UE 104. The capability exchange between the target UE 104 and the system may happen on a demand basis, or the capability information may be shared unsolicited. The AMF 106-a/LMF 106-b may be aware of the capability of the TRP 102 and the target UE 104 involved in positioning. The capability information may contain information like the frequency range supported by the TRP 102 and the target UE 104 (FR1, FR2, or both FR1 and FR2, and positioning frequency layer (PFL)), the capability of performing (or reporting) the measurement at the RF carrier level, at the sub-carrier level, at both RF carrier level and subcarrier, with respect to the ARP, or able to report the phase measurement of the virtual carrier, the positioning methods supported by the TRP 102 and the target UE 104 involved in positioning, for example,(carrier phase, DL-TDoA, UL-TDoA, Multi-RTT, DL-AoD, UL-AoA, E-CID), the method supported for integer ambiguity resolution, whether the measuring node supports the pseudo-range method or virtual carrier method or supports the use of the existing measurements like RSTD, RToA, and Rx-Tx time difference, the capability of identifying the LoS and non-LoS signal, and if supported, then the measurements corresponding to the LoS and non-LoS signal are supported or not supported. Further, based on the capability information, the AMF 106-a/LMF 106-b may choose the optimal resources and the measurements to enable the target UE 104 to estimate the location of the target UE 104. The information exchanges may be carried out between the AMF 106-a/LMF 106-b, the TRP 102 and the target UE 104.

In one embodiment, when the target UE 104 acts as a measuring entity, the AMF 106-a/LMF 106-b may request the TRP 102 to assist in downlink positioning. The TRP 102 may provide the configuration information to the target UE 104 and the AMF 106-a/LMF 106-b about the downlink signal and the time and frequency resources to be used to enable the measurements at the target UE 104. The configuration information may contain PRS configuration (such as periodicity, timing gap, resources, if the signal is unicasted or broadcasted, etc.) to be used for downlink transmission of the signals. The TRP 102 may report configuration information regarding the downlink signal and the resources to the AMF 106-a/LMF 106-b used for the measurement by the target UE 104. The AMF 106-a/LMF 106-b may use the configuration information to coordinate among the target UE 104 and the TRP 102. The AMF 106-a/LMF 106-b may provide information regarding the measurement to be performed (or be reported) is provided to the target UE 104. The information may contain whether the measurement to be performed (or reported) at the RF carrier level, at the sub-carrier level, at both the RF carrier level and subcarrier, with respect to the ARP, or reporting the phase of virtual carrier, or some combination of all the listed measurements granularities. The AMF 106-a/LMF 106-b may provide information to the target UE 104 regarding the nature or type of measurement that needs to be reported. The AMF 106-a/LMF 106-b may provide information regarding the gap between the two observations in the frequency domain if the measurement is done on more than one frequency to the target UE 104. The AMF 106-a/LMF 106-b may provide the distance estimated between the TRP 102 and the target UE 104 in terms of actual distance or in terms of time. The AMF 106-a/LMF 106-b may provide methods for integer ambiguity resolution and the number of each type of measurement to be performed. In the case, if the information regarding the gap between the two observations in the frequency domain if the measurement is done on more than one frequency is not informed to the target UE 104 explicitly, then timing advance may be used to decide the gap between the frequency measurement. If all the information is not provided explicitly to the target UE 104, then the target UE 104 may decide all the information on its own based on some preconfigured parameters or past system information.

The AMF 106-a/LMF 106-b may explicitly indicate if the target UE 104 needs to use the measurement performed on LoS signal to estimate its location or the target UE 104 may use the measurements performed on non-LoS signals along with LoS signals to estimate its position. Some information regarding measuring entities like the TRP 102 may also be required by the target UE 104. The AMF 106-a/LMF 106-b may provide information containing the identification information (TRP ID, Cell ID, Resource ID) about the TRP 102, the geographical location of the TRP 102, the configuration information of the signals to be measured and timing advance to the target UE 104. The information may be either directly conveyed by the TRP 102 or may be conveyed by the AMF 106-a/LMF 106-b by gathering information and transmitting to the target UE 104. After completing the exchange of assistance information and setting up the context, the TRP 102 may commence the transmission of the DL signal, and the target UE 104 may perform the measurements. The target UE 104 may perform the measurement and estimates its location based on the assistance information provided by the AMF 106-a/LMF 106-b and the TRP 102, and measurements carried out at the target UE 104. When the target UE 104 estimates its location, it may or may not convey its location back to the AMF 106-a/LMF 106-b. If the AMF 106-a/LMF 106-b requests the location information from the target UE 104, the target UE 104 may provide the position information to the AMF 106-a/LMF 106-b, else, the target UE 104 may provide the position information directly to the requesting application.

In one aspect, the carrier phase measurement may be viewed as the additional measurement over the already standardized measurement methods. The following table provides the details on measurements used for different methods in present positioning methods.

TABLE 1
Positioning methods and associate measurements in NR positioning

| | UE | RAN | |
|---|---|---|---|
| Method | measurements | measurements | LMF |
| UL-TDoA | — | RTOA, | Estimate position |
| | | UL-SRS-RSRP | using reported RToA |
| | | and UL-SRS- | and location of TRPs |
| | | reference | |
| | | signal received | |
| | | path power | |
| | | (RSRPP) | |
| DL-TDoA | RSTD from | — | Estimate position |
| | multiple TRPs, | | using reported RSTD |
| | DL-PRS-RSRP | | and location of TRPs |
| | and | | |
| | DL-PRS-RSRPP | | |
| M-RTT | UE Tx-RX time | TRP Tx-RX time | Estimate position |
| | difference of | difference of | based on RTT |
| | arrival | arrival | |
| UL-AoA | — | AoA value | Estimate position |
| | | | based on AoA |
| DL-AoD | RSRP per beam | Beam | Estimate AoDs and |
| | | information | use them to estimate |
| | | | the position |
| ECID | RSRP/beam | TA and | Estimate ToAs, AoDs |
| | | Beam-RSRP | and use them to |
| | | | estimate the position |

The position of the target UE 104 may be estimated using at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method.

In one embodiment, the position of the target UE 104 may be estimated using the DL-TDoA positioning method. In DL-TDoA, the target UE 104 may receive the at least one PRS from the TRP 102 and may calculate the Time of Arrival (ToA) of the at least one PRS. The target UE 104 may take a ToA of the TRP 102 as a reference to compute a Reference Signal Time Difference (RSTD). The target UE 104 may send the RSTD measurements to the AMF 106-a/LMF 106-b to compute the position of the target UE 104 using known geographical coordinates of the TRP 102. In DL-TDoA, the target UE 104 may be configured optionally to measure Downlink PRS Reference Signal Received Power (DL PRS-RSRP) and Downlink PRS Reference Signal Received Path Power (DLPRS-RSRPP). DL PRS-RSRP may be defined as the linear average over the power contributions (in [W]) of the resource elements that carry DL PRS configured for RSRP measurements within the considered measurement frequency bandwidth. DL PRS-RSRPP may be defined as the power of the linear average of the channel response at the i-th path delay of the resource elements that carry DL PRS signal configured for the measurement, where DL PRS -RSRPP for the 1st path delay may be the power contribution corresponding to the first detected path in time.

If the AMF 106-a/LMF 106-b decides to use DL-TDoA for positioning, the AMF 106-a/LMF 106-b may initiate the procedure for DL-TDoA. For better accuracy, the AMF 106-a/LMF 106-b may enable the carrier phase measurement over the at least one PRS configured to measure the RSTD for DL-TDoA based on the capability of the target UE 104. The AMF 106-a/LMF 106-b may transmit a capability request message to the target UE 104, where the capability may comprise the carrier phase measurement capability and the capability to measure the integer ambiguity. Upon receiving the capability request message from the AMF 106-a/LMF 106-b, the target UE 104 may transfer the carrier phase measurement capability along with other capabilities. This may include the carrier phase method, a Boolean indicator indicating integer ambiguity resolution possible at target UE 104 (1 indicate possible 0 otherwise).

The AMF 106-a/LMF 106-b may receive assistance information from the TRP 102. The assistance information may comprise at least one of Physical Cell Identity (PCI), Global Cell Identity (GCI), Absolute Radio Frequency Channel Number (ARFCN), and TRP IDs of the TRPs served by the TRP 102, Timing information of TRPs served by the TRP 102, DL-PRS configuration of the TRP 102, SSB information of the TRP 102, Spatial direction information of the DL-PRS resources of the TRP 102, Geographical coordinates information of the DL-PRS resources of the TRP 102, TRP type and On-demand DL-PRS information. Specific to carrier phase measurement, the assisting information may comprise timing advance and the integer ambiguity value of the TRP 102.

The AMF 106-a/LMF 106-b may initiate the procedure to measure the DL-TDoA with carrier phase measurements based on the capability of the target UE 104 and assistance information received from the TRP 102. The AMF 106-a/LMF 106-b may transfer assistance information comprising PCIs, GCIs, ARFCN, and PRS IDs of candidate NR TRPs for measurement, Timing relative to the serving (reference) TRP of candidate NR TRPs, DL-PRS configuration of candidate NR TRPs, SSB information of the TRPs, Spatial direction information (e.g. azimuth, elevation etc.) of the DL-PRS Resources of the TRP 102, geographical coordinates of the TRP 102 in case of UE based positioning, fine timing relative to the serving (reference) TRP of candidate NR TRPs, PRS -only TP indication, The association information of DL-PRS resources with TRP Tx TEG ID, LoS/non-LoS indicators, on-demand DL-PRS-Configurations etc. The AMF 106-a/LMF 106-b may transfer assistance information as integer ambiguity if carrier phase measurement is reported, the virtual carrier wavelength to be used if virtual carrier based method is used for carrier phase measurement, timing advance information of TRP 102 etc.

The TRP 102 may send the at least one PRS to the target UE 104. The target UE 104 may measure RSTD measured as the difference of time of arrival (ToA) of the at least one PRS from the observed TRP 102 and ToA of the at least one PRS from the reference TRP 102, optionally DL-PRS-RSRP, DL-PRS-RSRPP, differential carrier phase measured as the difference of carrier phase of the first path of the at least one PRS received at the observed TRP 102 and carrier phase of the first path of the at least one PRS received at the reference TRP 102, carrier phase of the first path of PRS received at observed TRP, differential carrier phase measured as the difference of carrier phase measured over received PRS at the observed TRP 102 and carrier phase of received PRS at the reference TRP 102 and carrier phase measured over received PRS at the observed TRP 102. The AMF 106-a/LMF 106-b may enable optional measurements based on the capability of the target UE 104.

In UE assisted mode of positioning, upon receiving the measurement, the AMF 106-a/LMF 106-b may run the positioning estimation algorithm based on the available measurements and derive the positioning of the target UE 104. The estimated position may be absolute, relative to one of the nodes which includes TRP 102, the target UE 104, and distance-based ranging.

In UE base mode of positioning, the final positioning estimate may be provided by the target UE 104 to the AMF 106-a/LMF 106-b, and the positioning request may be initiated by the network or the AMF 106-a/LMF 106-b. If the request is network originated then by the target UE 104 may forward final positioning estimate to the application requesting the position.

In one embodiment, the position of the target UE 104 may be estimated using the UL-TDoA positioning method. In the UL-TDoA, the target UE 104 may transmit the SRS as the at least one PRS to the TRP 102 and may calculates the Time of Arrival (ToA) of the at least one PRS. The target UE 104 may compute a Relative Time of Arrival (RToA) based on the ToA of the at least on PRS. The TRP 102 may send the RToA measurements to the AMF 106-a/LMF 106-b to compute the position of the target UE 104 using known geographical coordinates of the TRP 102. In UL-TDoA, the target UE 104 may be configured optionally to measure Uplink PRS Reference Signal Received Power (UL PRS-RSRP) and Uplink PRS Reference Signal Received Path Power (UL PRS-RSRPP).

The UL SRS-RSRP may be defined as the linear average of the power contributions (in [W]) of the resource elements carrying sounding reference signals (SRS). The UL SRS-RSRP may be measured over the configured resource elements within the considered measurement frequency bandwidth in the configured measurement time occasions. The UL SRS-RSRPP may be defined as the power of the linear average of the channel response at the i-th path delay of the resource elements that carry the received UL SRS signal configured for the measurement, where the UL SRS-RSRPP for 1st path delay is the power contribution corresponding to the first detected path in time.

If the AMF 106-a/LMF 106-b uses the UL-TDoA positioning method, the AMF 106-a/LMF 106-b may enable measurement of carrier phase over the at least one PRS configured for the RToA measurement based on the capability of the TRP 102 for better accuracy. In the capability request message, the AMF 106-a/LMF 106-b may require the TRP 102 to provide details about the carrier phase measurement method supported and capability to measure the integer ambiguity. Upon receiving the capability request message from the AMF 106-a/LMF 106-b, the TRP 102 may transfer the carrier phase measurement capability along with other capabilities. This may include the carrier phase method, a Boolean indicator indicating integer ambiguity resolution possible at the TRP end (1 indicate it is possible; 0 otherwise).

The AMF 106-a/LMF 106-b may receive assistance information from the TRP 102, wherein the assistance information comprises at least one of PCI, GCI, ARFCN, and TRP IDs of the TRP 102, SSB information of the TRP 102, association information of the PRS resources with the target UE 104, PRS configuration information, Timing information of the TRP 102, Geographical coordinates information of the DL-PRS Resources of the TRP 102, timing advance, and integer ambiguity value of the TRP 102.

Upon reception of capability and assistance information the AMF 106-a/LMF 106-b may request the TRP 102 to provide location measurements comprising at least one of a New Radio Cell Global Identity (NCGI) and TRP ID of the measurement, the RToA, UL PRS -RSRP, UL PRS-RSRPP, multiple UL Angle of Arrival (AoA), PRS resource type, time stamp of the measurement, quality for each measurement, beam information for each measurement, LoS/NLoS information for each measurement, Antenna Reference Point (ARP) ID of the measurement, the carrier phase over the at least one PRS, integer ambiguity, phases per antenna port/panel/antenna elements, Antenna Reference Point, and Phase Correction Offsets with regard to carrier phase reporting. The TRP 102 may provide this information in predefined container of message to the AMF 106-a/LMF 106-b, if the AMF 106-a/LMF 106-b is the positioning measuring entity or estimate these values as per instruction and use them to calculate position of the target UE 104.

Upon receiving the measurement, the AMF 106-a/LMF 106-b may run the positioning estimation algorithm based on the available measurements and derive the positioning of the target UE 104. The estimated position may be absolute, relative to one of the nodes which includes TRP 102, the target UE 104, and distance-based ranging.

In one embodiment, the position of the target UE 104 may be estimated using the DL-AoD positioning method. In the DL-AoD method, the TRP 102 may transmit multiple beams in specific spatial angle (direction), and target UE 104 may measure the beam strength in term of received power over RS (e.g. PRS). Estimated received power may be measured in terms of RSRP, RSRPP, Received Signal Strength Indicator (RSSI), Signal to Noise Ratio (SNR) and Signal to Interference and Noise Ratio (SINR).

In the DL-AoD method, the AMF 106-a/LMF 106-b may request capability information of the target UE 104 or the target UE 104 may report capability in unsolicited message. For better accuracy of the measurement, the target UE 104 may be configured with carrier phase-based positioning along with DL-AoD based method if it is capable doing the carrier phased based positioning. The target UE 104 may transmit the capability information to the AMF 106-a/LMF 106-b, wherein the capability information comprises a method to measure the carrier phase and a Boolean indicator to indicate a possibility of integer ambiguity resolution.

The AMF 106-a/LMF 106-b may provide assistance information from the target UE 104, wherein the assistance information may comprise at least one of carrier phase measurement method, integer ambiguity value, type of measurements to be reported like per subcarrier, number of sub-carrier for which measurement to be reported, carrier phase per antenna element/port/panel, PRS resources to measure carrier phase, expected carrier phase window, and additional paths with power along with carrier phases per path.

Upon receiving assistance information, the target UE 104 may receive the at least one PRS configured per TRP 102 and may report the measurement to either the TRP 102 or the AMF 106-a/LMF 106-b with predefined resolution. If more than one measurement are reported, the target UE 104 may report as differential measurement, wherein one of the measurement may be sent as original value and other measurements may be reported as differential values with regard to selected measurement with original value.

Upon receiving the measurement, the AMF 106-a/LMF 106-b or the TRP 102 may run the positioning estimation algorithm based on the available measurements and derive the positioning. The estimated position may be absolute, relative to one of the nodes which includes TRP 102, the target UE 104, and distance-based ranging.

The reported carrier measurement per antenna port/element may be used to estimate the azimuth and zenith angle of arrival at the target UE 104. This may be used along with estimated AoD to get the integrity of estimated AoD by estimating likelihood of LOS path-based measurement. This may be used in measurement selection algorithm at the AMF 106-a/LMF 106-b.

In one embodiment, the position of the target UE 104 may be estimated using the UL-AoA positioning method. In the UL-AoA method, the target UE 104 may transmit the at least one PRS to the TRP 102. The TRP 102 may receive multiple beams from the target UE 104 in a spatial angle, wherein a geometry and an inter element distance of the multiple beams are pre-defined.

In the UL-AoA method, the AMF 106-a/LMF 106-b may request capability from the target UE 104 and may request assistance information from TRP 102. Upon receiving the capability and assistance information, the AMF 106-a/LMF 106-b may configure for UL-AOA method with carrier phase measurement. In AoA estimation, the TRP 102 may measure the arrived signal at each antenna element or port over single or multiple panels. The TRP 102 may report the target UE 104 at least azimuth and zenith angle of arrival at the TRP 102 and carrier phase or received signal per antenna port. The target UE 104 may use this information jointly or individually to estimate the location of the target UE 104 by knowing location of TRP 102.

In the above detailed description, reference is made to the accompanying drawings that form a part thereof and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method for positioning a third node in a wireless communication system, the method comprising:
receiving, by at least one second node (102), a capability-request signal from at least one first node (106);
transmitting, by the at least one second node (102), a capability-response signal to the at least one first node (106), wherein the capability-response signal comprises at least one of at least one frequency resource supported, at least one supported positioning method, support for carrier phase positioning, at least one measurement supported, at least one granularity of performing the at least one measurement supported and at least one technique supported to resolve integer ambiguity;
transmitting, by the at least one second node (102), an assistance information to the at least one first node (106), wherein the assistance information comprises at least one of the at least one frequency resource to be used for the measurement, the at least one measurement to be used, the at least one granularity of performing the at least one measurement, the at least one technique supported to resolve integer ambiguity, at least one reference signal configuration information and at least one scheduling information of at least one reference signal to be used for the measurement;
transmitting, by the at least one second node (102), the configuration information of the at least one reference signal to the at least one third node (104);
receiving, by the at least one second node (102), the at least one reference signal from the at least one third node (104);
performing, by the at least one second node (102), at least one measurement on the at least one reference signal, wherein the at least one measurement is with respect to Antenna Reference Point; and
transmitting, by the at least one second node (102), at least one report comprising the at least one measurement to the at least one first node (106), wherein the at least one first node (106) estimates a position of the at least one third node (104) based on the at least one report received from the at least one second node (102),
wherein the at least one measurement comprises at least one of at least one carrier phase measurement and at least one timing-based measurement, of the at least one reference signal received from the at least one third node (104), and
wherein the at least one carrier phase measurement comprises of at least one carrier phase of at least one the received reference signal and at least one timestamp of the measurement.

2. The method as claimed in claim 1, wherein the at least one first node (106) is one of a positioning server, a location management function (LMF) server, an Access and Mobility Management Function (AMF) server, and sidelink positioning/ranging server;
the at least one second node (102) is one of a base station, a gNB, an eNB, a relay node, an integrated access and backhaul (IAB) node, a Vehicle-to-Everything (V2X) node, a Transmission Reception Point (TRP), anchor user equipment (UE) and a repeater in a cellular network; and
the at least one-third node (104) is one of the target UE and Positioning reference unit (PRU), wherein the target UE is the node whose location is to be determined.

3. The method as claimed in claim 1, the method further comprises receiving, by the at least one second node (102), a positioning-request signal from at least one of the at least one first node (106) and the at least one third node (104), to assist at least one of the at least one first node (106) and the at least one third node (104) in estimating the position of the at least one third node (104).

4. The method as claimed in claim 1, wherein the assistance information is transmitted by the at least one second node (102) to the at least one first node (106) upon receiving the assistance information-request from the at least one first node (106).

5. The method as claimed in claim 1, wherein the Antenna Reference Point comprises at least one of an antenna connector, transceiver array boundary connector, physical antenna, and central radiating region of antenna.

6. The method as claimed in claim 1, wherein the timing-based measurements comprises at least one of:
second node (102) Rx-Tx time difference, wherein Rx-Tx time difference is the difference between the time at which the at least one reference signal is received by the at least one of second node (102) and the time at which a reference signal is transmitted by the same second node (102);
third node (104) Rx-Tx time difference, wherein Rx-Tx time difference is the difference between the time at which the at least one reference signal is received by the at least one of third node (104) and the time at which a reference signal is transmitted by the same third node (104);
relative time of arrival (RTOA), wherein the RTOA is the relative time taken by reference signal with respect to a reference time, to reach from the at least one third node (104) to the at least one second node (102); and
reference signal time difference (RSTD), wherein the RSTD is the difference between the relative time taken by reference signal to reach from the at least one second node (102) to the at least one third node (104) and the relative time taken by reference signal to reach from one of an another second node (102) to of the same third node (104).

7. The method as claimed in claim 1, wherein when at least the at least one carrier phase measurement and timing-based measurements are supported, the capability information comprises at least one indication that the at least one second node (102) is capable of measuring and reporting the at least one carrier phase on the same reference signal resources as configured for timing-based measurements.

8. The method as claimed in claim 1, wherein when at least the at least one carrier phase measurement and timing-based measurements are supported, the configuration signal comprises at least one indication for the at least one second node (102) to report the at least one carrier phase on the same reference signal resources as configured for timing-based measurements.

9. The method as claimed in claim 1, wherein when at least the at least one carrier phase measurement is supported, the capability information comprises at least one indication that the at least one carrier phase measurement is supported for at least one of first path and multiple paths.

10. The method as claimed in claim 1, wherein when the at least one carrier phase measurement is supported, the configuration signal comprises at least one indication that whether the at least one carrier phase measurement is to be reported for multiple paths or not.

11. The method as claimed in claim 1, wherein the at least one carrier phase measurement for the first path is reported, and additionally the at least one carrier phase measurement for other multiple paths is reported if configured, wherein the first path is a line of sight (LoS) path.

12. The method as claimed in claim 1, wherein the at least one reference signal is a sounding reference signal (SRS) and the configuration of the at least one reference signal comprises of at least one of the at least one reference signal resource and at least one resource set.

13. The method as claimed in claim 12, wherein receiving the at least one reference signal is a sounding reference signal (SRS), the SRS is received in a full stagger pattern, the plurality of SRS signals is concatenated over a full frequency band of transmission and the at least one second node (102) measures the at least one carrier phase over the concatenated resource signals.

14. The method as claimed in claim 1, wherein the position of the at least one third node (104) is one of an absolute position with respect to global coordinates and a relative position with respect to the at least one first node (106) or the at least one second node (102), and distance between the at least one second node (102), and the at least one third node (104).

15. The measurement as claimed in claim 1, wherein the at least one carrier phase is difference between the phase of the received reference signal and the transmitted reference signal.

16. The measurement as claimed in claim 1, wherein performing the at least one carrier phase measurement on a plurality of received reference signals from a plurality of nodes is used to estimate the at least one carrier phase difference and report the at least one carrier phase difference to the at least one first node (106).

17. The measurement as claimed in claim 16, wherein the carrier phase difference is the difference between the at least one carrier phase of the received reference signal form one of the at least one third node (104) and the at least one carrier phase of the received reference signal from one of an another at least one third node (104).

18. The method as claimed in claim 1, wherein the at least one second node (102) calibrates and reports the errors occurring at the at least one second node (102) during the at least one carrier phase measurement, and wherein the errors include Transmission-Reception Points (TRP) synchronization error, Carrier Frequency Offset (CFO) error, antenna phase center offset, and oscillator drift.

19. The method as claimed in claim 1, wherein the at least one second node (102) estimates the quality of the at least one carrier phase measurement and reports it to the at least one first node (106), wherein the quality of the at least one carrier phase measurement is based on a residual error in the phase based on the at least one carrier phase measured and reported.

20. The method as claimed in claim 1, wherein the capability information further comprises at least one of frequency ranges supported, Positioning Frequency Layer (PFL), granularity of performing the at least one measurement at carrier level, subcarrier level, and both, or able to report the phase measurement of a virtual carrier, positioning methods supported comprising of at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method, capability of identifying and reporting the measurement for Line of Sight (LoS) and Non Line of Sight (NLoS) signals, and at least one technique supported to resolve integer ambiguity.

21. The method as claimed in claim 1, wherein the capability information further comprises at least one of a method to measure the at least one carrier phase and a Boolean indicator to indicate possibility of integer ambiguity resolution.

22. The method as claimed in claim 1, wherein the assistance information further comprises at least one of a Physical Cell Identity (PCI), Global Cell Identity (GCI), Absolute Radio Frequency Channel Number (ARFCN), an ID of the at least one second node (102) serving the at least one third node (104), timing information of the at least one second node (102) serving the at least one third node (104), SRS configuration of the at least one third node (104) served by the at least one second node (102), SSB information of the at least one third node (104), Spatial direction information of the SRS resources of the at least one third node (104) served by the at least one second node (102), Geographical coordinates information of the at least one second node (102) serving the at least one third node (104), node type, On-demand SRS information, timing advance, at least one technique supported to resolve integer ambiguity, and integer ambiguity value.

23. The method as claimed in claim 1, wherein the at least one carrier phase measurements are performed over a plurality of frequency resources, the measurements reported further comprises at least one of the frequency resource values per carrier phase measurement, and the difference between the frequency resource values per carrier phase measurement, and wherein the frequency resource values comprise of at least one of a frequency carrier, a frequency subcarrier, a frequency band, and a frequency range.

24. The method as claimed in claim 1, wherein the at least one report further comprises at least one of channel response in time and frequency, difference between two measurements in frequency domain for multiple frequency resources, frequency spacing between the at least one pair of frequency resources, distance between the at least one second node (102) and the at least one third node (104), slope of the phase measurement when the at least one measurement is performed over plurality of frequency resources.

25. The method as claimed in claim 1, wherein the at least one carrier phase measurement corresponding to at least one of the first path and the additional paths, comprises of at least one likelihood value, wherein the likelihood value is at least one of a soft value ranging between 0 and 1, and a hard value comprising of one of 0 and 1, wherein the likelihood values corresponds to likelihood whether the at least one carrier phase measurement is for one of LoS path, and NLoS path.

26. The method as claimed in claim 1, wherein the at least one report further comprises signal strength corresponding to the measurement, errors in measurement, wherein the errors include clock error, Timing Error Group (TEG), and initial clock error, a New Radio Cell Global Identity (NCGI) and TRP ID of the measurement, the relative time of arrival (RToA), UL SRS-RSRP, UL SRS-RSRPP, multiple UL Angle of Arrival (AoA), SRS resource type, time stamp of the measurement, quality for each measurement, beam information for each measurement, Antenna Reference Point (ARP) ID of the measurement, the carrier phase over the at least one SRS, integer ambiguity value, carrier phases per antenna port, carrier phases per antenna panel, carrier phases per antenna element, and Phase Correction Offsets.

27. The method as claimed in claim 1, wherein the integer ambiguity value denotes an integer number of wave cycles between the at least one second node (102) and the at least one third node (104), and wherein the method further comprises at least one of:
determining, by the at least one second node (102), the integer ambiguity value;
transmitting, by the at least one second node (102), the integer ambiguity value to the at least one first node (106) one of implicitly and explicitly; and
determining, by the at least one first node (106), the integer ambiguity value based on the at least one report.

28. The method as claimed in claim 1, wherein to resolve the ambiguity, the method further comprises:
configuring, by the at least one second node (102), at least one third node (104) to transmit the at least one reference signal in a carrier frequency having wavelength greater than the actual distance between the at least one second node (102) and the at least one third node (104);
measuring, by the at least one second node (102), the at least one carrier phase of the at least one reference signal in the single carrier frequency using a carrier of wavelength greater than the actual distance between the at least one second node (102) and the at least one third node (104); and
transmitting, by the at least one second node (102), the at least one report comprising of the measurements to the at least one first node (106).

29. The method as claimed in claim 1, wherein to resolve the ambiguity, the method further comprises:
receiving, by the at least one second node (102), at least one of at least one reference signal and at least one pseudo-random code sequence on the at least one frequency resource from the at least one third node (104);
measuring, by the at least one second node (102), at least one of the at least one carrier phase of the at least one reference signal and the at least one carrier phase of the at least one pseudo-random code sequence on the at least one frequency resource, wherein the integer ambiguity is resolved using at least one of the at least one carrier phase of the at least one reference signal and the at least one carrier phase of the at least one pseudo-random code sequence; and
transmitting, by the at least one second node (102), the at least one report comprising of the measurements to the at least one first node (106),
wherein at least one pseudo-random code sequence is at least a physical random access channel (PRACH) preamble signal.

30. The method as claimed in claim 1, wherein when the at least one measurements comprise of the at least one carrier phase measurement over a plurality of frequency resources, the at least one report comprises of the at least one carrier phase difference between at least one pair of frequency resources, which is used to resolve the integer ambiguity.

31. A method for positioning a third node in a wireless communication system, the method comprising:
receiving, by at least one third node (104), a capability request signal from at least one of at least one first node (106) and at least one second node (102);
transmitting, by the at least one third node (104), a capability response signal to at least one of the at least one first node (106) and the at least one second node (102), wherein the capability response signal comprises at least one of at least one frequency resource supported, at least one supported positioning method, support for carrier phase positioning, at least one measurement supported, at least one granularity of performing the at least one measurement supported, at least one technique supported to resolve integer ambiguity;
receiving, by the at least one third node (104), a configuration signal from at least one of the at least one first node (106) and the at least one second node (102), wherein the configuration signal comprises at least one of the at least one frequency resource to be used for the measurement, at least one measurement to be used, at least one granularity of performing the at least one measurement, at least one method supported to resolve integer-ambiguity, and at least one scheduling information and configuration information of the at least one reference signal to be used for the measurement;
receiving, by the at least one third node (104), at least one reference signal from the at least one second node (102);
performing, by the at least one third node (104), at least one of at least one measurement on the at least one reference signal and estimating a position of the at least one third node (104), wherein the at least one measurement is with respect to Antenna Reference Point; and
transmitting, by the at least one third node (104), at least one report comprising at least one of at least one measurement and the position of the at least one third node (104) to at least one of the at least one first node (106) and the at least one second node (102),
wherein the at least one measurement comprises at least one of at least one carrier phase measurement and at least one timing-based measurement, of the at least one reference signal received from the at least one second node (102), and
wherein the at least one carrier phase measurement comprises of at least one carrier phase of at least one the received reference signal and at least one timestamp of the measurement.

32. The method as claimed in claim 31, wherein the at least one first node (106) is one of a positioning server, a location management function (LMF) server, an Access and Mobility Management Function (AMF) server, and sidelink positioning/ranging server, the at least one second node (102) is one of a base station, a gNB, an eNB, a relay node, an integrated access and backhaul (IAB) node, a Vehicle-to-Everything (V2X) node, a Transmission Reception Point (TRP), anchor user equipment (UE) and a repeater in a cellular network, and the at least one-third node (104) is one of the target UE and Positioning reference unit (PRU), wherein the target UE is the node whose location is to be determined.

33. The method as claimed in claim 31, the method further comprises transmitting, by the at least one third node (104), a positioning-request signal to at least one of the at least one first node (106) and the at least one second node (102), to assist the at least one third node (104) in estimating the position of the at least one third node (104).

34. The method as claimed in claim 31, the method further comprises receiving, by the at least one third node (104), the positioning-request signal from at least one of the at least one first node (106) and the at least one second node (102), to assist the at least one first node (106) in estimating the position of the at least one third node (104).

35. The method as claimed in claim 31, wherein the Antenna Reference Point comprises at least one of an antenna connector, transceiver array boundary connector, physical antenna, and central radiating region of antenna.

36. The method as claimed in claim 31, wherein the timing-based measurements comprises at least one of second node (102) Rx-Tx time difference wherein Rx-Tx time difference is the difference between the time at which at least one reference signal is received by the at least one of second node (102) and the time at which a reference signal is transmitted by the same second node (102);
third node (104) Rx-Tx time difference wherein Rx-Tx time difference is the difference between the time at which at least one reference signal is received by the at least one of third node (104) and the time at which a reference signal is transmitted by the same third node (104);
relative time of arrival (RTOA) wherein the RTOA is the relative time taken by reference signal with respect to a reference time, to reach from the at least one third node (104) to the at least one second node (102); and
reference signal time difference (RSTD) wherein the RSTD is the difference between the relative time taken by reference signal to reach from the at least one second node (102) to the at least one third node (104) and the relative time taken by reference signal to reach from one of another second node (102) to of the same third node (104).

37. The method as claimed in claim 31, wherein when the at least one carrier phase measurement and timing-based measurements are supported, the capability information comprises at least one indication that the at least one third node (104) is capable of measuring and reporting the at least one carrier phase on the same reference signal resources as configured for timing -based measurements.

38. The method as claimed in claim 31, wherein when at least the at least one carrier phase measurement and timing-based measurements are supported, the configuration signal comprises at least one indication for the at least one third node (104) to report the at least one carrier phase on the same reference signal resources as configured for timing-based measurements.

39. The method as claimed in claim 31, wherein when at least the at least one carrier phase measurement is supported, the capability information comprises at least one indication that the at least one carrier phase measurement is supported for at least one of first path and multiple paths.

40. The method as claimed in claim 31, wherein when at least the at least one carrier phase measurement is supported, the configuration signal comprises at least one indication that whether the at least one carrier phase measurement is to be reported for multiple paths or not.

41. The method as claimed in claim 31, wherein the at least one carrier phase measurement for the first path is reported, and additionally the at least one carrier phase measurement for other multiple paths is reported if configured, wherein the first path is a line of sight (LoS) path.

42. The method as claimed in claim 31, wherein when the at least one report comprises of only measurements, the at least one first node (106) estimates the position of at least one third node (104) based on the at least one report received form at least one third node (104).

43. The method as claimed in claim 31, wherein the at least one reference signal is a positioning reference signal (PRS) and the configuration of the at least one reference signal comprises of at least one of the at least one reference signal resource and resource set.

44. The method as claimed in claim 31, wherein receiving the at least one reference signal is a positioning reference signal (PRS), and the PRS in a full stagger pattern, the plurality of PRS signals is concatenated over a full frequency band of transmission and the at least one third node (104) measures the at least one carrier phase over the concatenated resource signals.

45. The method as claimed in claim 31, wherein the position of the at least one third node (104) is one of an absolute position with respect to global coordinates and a relative position with respect to the at least one first node (106) or the at least one second node (102), and distance between the at least one third node (104), and the at least one second node (102).

46. The measurement as claimed in claim 31, wherein the at least one carrier phase is difference between the phase of the received reference signal and the transmitted reference signal.

47. The measurement as claimed in claim 31, wherein performing the at least one carrier phase measurement on a plurality of received reference signals from a plurality of nodes is used to estimate the at least one carrier phase difference and report the at least one carrier phase difference to at least one of the at least one first node (106) and the at least one second node (102).

48. The measurement as claimed in claim 47, wherein the at least one carrier phase difference is the difference between the at least one carrier phase of the received reference signal form one of the at least one second node (102) and the at least one carrier phase of the received reference signal from one of an another at least one second node (102).

49. The method as claimed in claim 31, wherein the at least one third node (104) calibrates and reports the errors occurring at the at least one third node (104) during the at least one carrier phase measurement, and wherein the errors include Transmission-Reception Points (TRP) synchronization error, Carrier Frequency Offset (CFO) error, antenna phase center offset, and oscillator drift.

50. The method as claimed in claim 31, wherein the at least one third node (104) estimates the quality of the at least one carrier phase measurement and reports it to the at least one of the at least one first node (106) and the at least one second node (102), wherein the quality of the at least one carrier phase measurement is based on a residual error in the phase based on the at least one carrier phase measured and reported.

51. The method as claimed in claim 31, wherein the capability information further comprises at least one of frequency ranges supported, Positioning Frequency Layer (PFL), granularity of performing the at least one measurement at carrier level, subcarrier level, and both, or able to report the phase measurement of a virtual carrier, positioning methods supported comprising of at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method, capability of identifying and reporting the measurement for Line of Sight (LoS) and Non Line of Sight (NLoS) signals, and at least one technique supported to resolve integer ambiguity.

52. The method as claimed in claim 31, wherein when the capability information comprises carrier phase positioning supported, the capability information further comprises a method to measure the at least one carrier phase and a Boolean indicator to indicate possibility of integer ambiguity resolution.

53. The method as claimed in claim 31, wherein method further comprises
receiving, by the at least one third node (104), assistance information from the at least one of the at least one first node (106) and the at least one second node (102), wherein the assistance information comprises at least one of Physical Cell Identity (PCI), Global Cell Identity (GCI), Absolute Radio Frequency Channel Number (ARFCN), and ID of the at least one second node (102) serving the at least one third node (104), Timing information of the at least one second node (102) serving the at least one third node (104), PRS configuration of the at least one second node (102) serving by the at least one third node (104), SSB information of the at least one second node (102), Spatial direction information of the PRS resources of the at least one second node (102) serving the at least one third node (104), Geographical coordinates information of the at least one second node (102) serving the at least one third node (104), node type, On-demand PRS information, timing advance, at least one technique supported to resolve integer ambiguity, and integer ambiguity value.

54. The method as claimed in claim 31, wherein the at least one carrier phase measurements are performed over a plurality of frequency resources, the measurements reported further comprises at least one of the frequency resource values per carrier phase measurement, and the difference between the frequency resource values per carrier phase measurement, and
wherein the frequency resource values comprise of at least one of a frequency carrier, a frequency subcarrier, a frequency band, and a frequency range.

55. The method as claimed in claim 31, wherein the at least one report further comprises at least one of channel response in time and frequency, difference between two measurements in frequency domain for multiple frequency resources, frequency spacing between the at least one pair of frequency resources, distance between the at least one second node (102) and the at least one third node (104), slope of the phase measurement when the at least one measurement is performed over plurality of frequency resources.

56. The method as claimed in claim 31, wherein the at least one carrier phase measurement corresponding to at least one of the first path and the additional paths comprises of at least one likelihood value, wherein the likelihood value is at least one of a soft value ranging between 0 and 1, and a hard value comprising of one of 0 and 1, wherein the likelihood values corresponds to likelihood whether the at least one carrier phase measurement is for one of LoS path and NLoS path.

57. The method as claimed in claim 31, wherein the at least one report further comprises signal strength corresponding to the measurement, errors in measurement, wherein the errors include clock error, Timing Error Group (TEG), and initial clock error, a New Radio Cell Global Identity (NCGI) and TRP ID of the measurement, the reference signal time difference (RSTD), DL PRS -RSRP, DL PRS-RSRPP, multiple DL Angle of Departure (AoD), PRS resource type, time stamp of the measurement, quality for each measurement, beam information for each measurement, Antenna Reference Point (ARP) ID of the measurement, the carrier phase over the at least one PRS, integer ambiguity value, carrier phases per antenna port, carrier phases per antenna panel, carrier phases per antenna element, and Phase Correction Offsets.

58. The method as claimed in claim 31, wherein the integer ambiguity value denotes an integer number of wave cycles between the at least one second node (102) and the at least one third node (104), and wherein the method further comprises at least one of:
determining, by the at least one third node (104), the integer ambiguity value;
transmitting, by the at least one third node (104), the integer ambiguity value to the at least one of the at least one first node (106) and the at least one second node (102) one of implicitly and explicitly; and
determining, by the at least one first node (106), the integer ambiguity value based on the at least one report.

59. The method as claimed in claim 31, wherein to resolve the ambiguity, the method further comprises:
receiving, by the at least one third node (104), the configuration from the at least one second node (102) to receive the at least one reference signal in a carrier frequency having wavelength greater than the actual distance between the at least one second node (102) and the at least one third node (104);
measuring, by the at least one third node (104), the at least one carrier phase of the at least one reference signal in the single carrier frequency using a carrier of wavelength greater than the actual distance between the at least one second node (102) and the at least one third node (104); and
transmitting, by the at least one third node (104), the at least one report comprising of the measurements to at least one of the at least one first node (106) and the at least one second node (102).

60. The method as claimed in claim 31, wherein to resolve the ambiguity, the method further comprises:
receiving, by the at least one third node (104), at least one of at least one reference signal and at least one pseudo-random code sequence on the at least one frequency resource from the at least one second node (102);
measuring, by the at least one third node (104), at least one of the at least one carrier phase of the at least one reference signal and the at least one carrier phase of the at least one pseudo-random code sequence on the at least one frequency resource, wherein the integer ambiguity is resolved using at least one of at least one carrier phase of the at least one reference signal and the at least one carrier phase of the at least one pseudo-random code sequence; and
transmitting, by the at least one third node (104), the at least one report comprising of the measurements to at least one of the at least one first node (106) and the at least one second node (102).

61. The method as claimed in claim 31, wherein when the at least one measurement comprise of the at least one carrier phase measurement over a plurality of frequency resources, the at least one report comprises of the at least one carrier phase difference between at least one pair of frequency resources, which is used to resolve the integer ambiguity.

62. A method for positioning a third node in a wireless communication system, the method comprising:
transmitting, by at least one first node (106), a capability request signal to at least one of at least one second node (102) and the at least one third node (104);
receiving, by the at least one first node (106), a capability response signal from at least one of the at least one second node (102) and the at least one third node (104), wherein the capability-response signal comprises at least one of at least one frequency resource supported, at least one supported positioning method, support for carrier phase positioning, at least one measurement supported, and at least one granularity of performing the at least one measurement supported and at least one technique supported to resolve integer ambiguity;
transmitting, by the at least one first node (106), an assistance information to at least one of the at least one second node (102) and the at least one third node (104), wherein the assistance information comprises at least one of the at least one frequency resource to be used for the measurement, at least one measurement to be used, at least one granularity of performing the at least one measurement, at least one method supported to resolve integer-ambiguity, and at least one scheduling information and configuration information of at least one reference signal to be used for the measurement; and
receiving, by the at least one first node (106), at least one report comprising of at least one measurement from at least one of the at least one second node (102) and the at least one third node (104); wherein the at least one first node (106) estimates a position of the at least one third node (104) based on the at least one report received from at least one of the at least one second node (102) and the at least one third node (104),
wherein the at least one measurement comprises at least one of at least one carrier phase measurement and at least one timing-based measurement of the at least one reference signal received, and
wherein the at least one carrier phase measurement comprises of at least one carrier phase of at least one the received reference signal and at least one timestamp of the measurement.

63. The method as claimed in claim 62, wherein the at least one first node (106) is one of a positioning server, a location management function (LMF) server, an Access and Mobility Management Function (AMF) server, and sidelink positioning/ranging server,
the at least one second node (102) is one of a base station, a gNB, an eNB, a relay node, an integrated access and backhaul (IAB) node, a Vehicle-to-Everything (V2X) node, a Transmission Reception Point (TRP), anchor user equipment (UE) and a repeater in a cellular network, and
the at least one-third node (104) is one of the target UE and Positioning reference unit (PRU), wherein the target UE is the node whose location is to be determined.

64. The method as claimed in claim 62, the method further comprises receiving, by the at least one first node (106), a positioning-request signal from at least one of the at least one first node (106) and the at least one third node (104), to assist at least one of the at least one first node (106) and the at least one third node (104) in estimating the position of the at least one third node (104).

65. The method as claimed in claim 62, the method further comprises transmitting, by the at least one first node (106), assistance information-request to at least one of the at least one second node (102) and the at least one third node (104).

66. The method as claimed in claim 62, wherein the Antenna Reference Point comprises at least one of an antenna connector, transceiver array boundary connector, physical antenna, and central radiating region of antenna.

67. The method as claimed in claim 62, wherein the timing-based measurements comprises at least one of
second node (102) Rx-Tx time difference, wherein the Rx-Tx time difference is the difference between the time at which at least one reference signal is received by the at least one of second node (102) and the time at which a reference signal is transmitted by the same second node (102),
third node (104) Rx-Tx time difference, wherein the Rx-Tx time difference is the difference between the time at which at least one reference signal is received by the at least one of third node (104) and the time at which a reference signal is transmitted by the same third node (104),
relative time of arrival (RTOA), wherein the RTOA is the relative time taken by reference signal with respect to a reference time, to reach form one of the at least one third node (104) to one of the at least one second node (102), and
reference signal time difference (RSTD), wherein the RSTD is the difference between the relative time taken by reference signal to reach from the at least one second node (102) to the at least one third node (104) and the relative time taken by reference signal to reach from one of an another at least one second node (102) to of the at least one third node (104).

68. The method as claimed in claim 62, wherein when at least the at least one carrier phase measurement and timing-based measurements are supported, the capability information comprises at least one indication that at least one of the at least one second node (102) and the at least one third node (104) is capable of measuring and reporting the at least one carrier phase on the same reference signal resources as configured for timing-based measurements.

69. The method as claimed in claim 62, wherein when at least the at least one carrier phase measurement and timing-based measurements are supported, the at least one first node (106) receives an information comprises at least one indication from at least one of the at least one second node (102) and the at least one third node (104) indicating that the at least one carrier phase is measured on the same reference signal resources as configured for timing-based measurements.

70. The method as claimed in claim 62, wherein when at least the at least one carrier phase measurement is supported, the capability information comprises at least one indication that the at least one carrier phase measurement is supported only for one of first path and multiple paths.

71. The method as claimed in claim 62, wherein when the at least one carrier phase measurement is supported, the configuration signal comprises at least one indication that whether the at least one carrier phase measurement is to be reported for multiple paths or not.

72. The method as claimed in claim 62, wherein the at least one carrier phase measurement for the first path is reported, and additionally the at least one carrier phase measurement for other multiple paths is reported if configured, wherein the first path is a line of sight (LoS) path.

73. The method as claimed in claim 62, wherein the at least one reference signal is at least one of a sounding reference signal (SRS) and a positioning reference signal (PRS) and the configuration of the at least one reference signal comprises of the at least one of at least one reference signal resource and resource set.

74. The method as claimed in claim 62, wherein the position estimated by the at least one first node (106) is one of an absolute position with respect to global coordinates and a relative position with respect to the at least one first node (106) or the at least one second node (102), and distance between the at least one second node (102), and the at least one third node (104).

75. The measurement as claimed in claim 62, wherein the at least one carrier phase measurement received by one of the at least one first node (106) is the difference between the phase of the received reference signal and the transmitted reference signal.

76. The measurement as claimed in claim 62, wherein the at least one carrier phase measurement report received by the at least one first node (106) comprises the at least one carrier phase difference estimated from the at least one carrier phase measurement on a plurality of received reference signals from a plurality of nodes.

77. The measurement as claimed in claim 76, wherein the at least one carrier phase difference is the difference between the at least one carrier phase of the received reference signal form one of the at least one second node (102) and the at least one carrier phase of the received reference signal from one of an another at least one second node (102).

78. The method as claimed in claim 62, wherein the at least one first node (106) receives the errors occurring at least one of the at least one second node (102) and the at least one third node (104) during the at least one carrier phase measurement, and wherein the errors include Transmission-Reception Points (TRP) synchronization error, Carrier Frequency Offset (CFO) error, antenna phase center offset, and oscillator drift.

79. The method as claimed in claim 62, wherein the at least one first node (106) receives the quality of the at least one carrier phase measurement and reports from at least one of the at least one second node (102) and the at least one third node (104), wherein the quality of the at least one carrier phase measurement is based on a residual error in the phase based on the at least one carrier phase measured and reported.

80. The method as claimed in claim 62, wherein the capability information further comprises at least one of frequency ranges supported, Positioning Frequency Layer (PFL), granularity of performing the at least one measurement at carrier level, subcarrier level, and both, or able to report the phase measurement of a virtual carrier, positioning methods supported comprising of at least one of a Downlink Time Difference of Arrival (DL-TDoA) positioning method, Uplink Time Difference of Arrival (UL-TDoA) positioning method, a Multiple Round Trip Time (Multi-RTT) positioning method, an Uplink Angle of Arrival (UL-AoA) positioning method, a Downlink Angle of Departure (DL-AoD) positioning method, Carrier Phased Based Positioning (CPP) method, Enhanced Cell-ID (E-CID) positioning method, capability of identifying and reporting the measurement for Line of Sight (LoS) and Non Line of Sight (NLoS) signals, and at least one technique supported to resolve integer ambiguity.

81. The method as claimed in claim 62, wherein when the capability information comprises carrier phase positioning supported, the capability information further comprises a method to measure the at least one carrier phase and a Boolean indicator to indicate possibility of integer ambiguity resolution.

82. The method as claimed in claim 62, wherein the assistance information further comprises at least one of a Physical Cell Identity (PCI), Global Cell Identity (GCI), Absolute Radio Frequency Channel Number (ARFCN), an ID of the at least one second node (102) serving the at least one third node (104), timing information of the at least one second node (102) serving the at least one third node (104), reference signal configuration of the at least one third node (104) served by the at least one second node (102), SSB information of the at least one third node (104), Spatial direction information of the reference signal resources of the at least one third node (104) served by the at least one second node (102), Geographical coordinates information of the at least one second node (102) serving the at least one third node (104), node type, On-demand reference information, timing advance, at least one technique supported to resolve integer ambiguity, and integer ambiguity value.

83. The method as claimed in claim 62, wherein the at least one carrier phase measurement is received over a plurality of frequency resources, the measurements reported further comprises at least one of the frequency resource values per carrier phase measurement, and the difference between the frequency resource values per carrier phase measurement,
wherein the frequency resource values comprise of at least one of a frequency carrier, a frequency subcarrier, a frequency band, and a frequency range.

84. The method as claimed in claim 62, wherein the at least one report further comprises at least one of channel response in time and frequency, difference between two measurements in frequency domain for multiple frequency resources, frequency spacing between the at least one pair of frequency resources, distance between the at least one second node (102) and the at least one third node (104), slope of the phase measurement when the measurement is performed over plurality of frequency resources.

85. The method as claimed in claim 62, wherein the at least one carrier phase measurement corresponding to at least one of the first path and the additional paths comprises of at least one likelihood value, wherein the likelihood value is at least one of a soft value ranging between 0 and 1, and a hard value comprising of one of 0 and 1, wherein the likelihood values corresponds to likelihood whether the at least one carrier phase measurement is for one of LoS path and a NLoS path.

86. The method as claimed in claim 62, wherein the at least one report further comprises signal strength corresponding to the measurement, errors in measurement, wherein the errors include clock error, Timing Error Group (TEG), and initial clock error, a New Radio Cell Global Identity (NCGI) and TRP ID of the measurement, the relative time of arrival (RToA), UL SRS-RSRP, UL SRS-RSRPP, multiple UL Angle of Arrival (AoA), SRS resource type, time stamp of the measurement, quality for each measurement, beam information for each measurement, Antenna Reference Point (ARP) ID of the measurement, the carrier phase over the at least one SRS, integer ambiguity value, carrier phases per antenna port, carrier phases per antenna panel, carrier phases per antenna element, and Phase Correction Offsets.

87. The method as claimed in claim 62, wherein the integer ambiguity value denotes an integer number of wave cycles between the at least one second node (102) and the at least one third node (104), and wherein the method further comprises at least one of
determining, by the at least one first node (106), the integer ambiguity value based on the at least one report; and
transmitting, by the at least one first node (106), the integer ambiguity value to the at least one of the at least one second node (102) and the at least one third node (104) one of implicitly and explicitly.

88. The method as claimed in claim 62, wherein to resolve the ambiguity, the method further comprises:
configuring, by the at least one first node (106), at least one of the at least one second node (102) and the at least one third node (104) to measure on the at least one reference signal in a carrier frequency having wavelength greater than the actual distance between the at least one second node (102) and the at least one third node (104); and
receiving, by the at least one first node (106), the measurement from at least one of the at least one second node (102) and the at least one third node (104), the at least one carrier phase of the at least one reference signal in the single carrier frequency using a carrier of wavelength greater than the actual distance between the at least one second node (102) and the at least one third node (104).

89. The method as claimed in claim 62, wherein to resolve the ambiguity, the method further comprises:
transmitting, by the at least one first node (106) to at least one of the at least one second and the at least one third node (104) a configuration information wherein the configuration information comprises measurement and reporting to be performed on at least one of at least one reference signal and at least one pseudo-random code sequence on the at least one frequency resource by the at least one of the at least one second and the at least one third node (104);
receiving, by the at least one first node (106), at least one of the at least one carrier phase of the at least one reference signal and the at least one carrier phase of the at least one pseudo-random code sequence on the at least one frequency resource, wherein the integer ambiguity is resolved using at least one of the at least one carrier phase of the at least one reference signal and the at least one carrier phase of the at least one pseudo-random code sequence; and
wherein at least one pseudo-random code sequence is at least a physical random access channel (PRACH) preamble signal.

90. The method as claimed in claim 62, wherein when the at least one measurement comprise of the at least one carrier phase measurement over a plurality of frequency resources, the at least one report comprises of the at least one carrier phase difference between at least one pair of frequency resources, which is used to resolve the integer ambiguity.
